(19) United States
(12) Patent Application Publication
(10) Pub. No.: US 2007/0288843 A1
(43) Pub. Date: Dec. 13, 2007

(54) AUTOMATIC LAYOUT SYSTEM AND AUTOMATIC LAYOUT METHOD

(75) Inventor: Jun MAKINO, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/759,546

(22) Filed: Jun. 7, 2007

(30) Foreign Application Priority Data
Jun. 13, 2006 (JP) 2006-163827

(51) Int. Cl. G06F 17/00; G06F 3/12

(52) U.S. Cl. 715/520; 715/517; 358/1.1

(57) ABSTRACT

In a variable printing system, content of a merchandise or the like (e.g., merchandise advertisement) extracted from a database can be arranged at the optimal position depending on a level of appeal or a priority of the content. In an automatic layout method for varying a layout of a sub-template for content depending on a size of the content to be laid out on a page, an area for flowing the sub-template is set in the page, position information is set in the page, content information is set for the content and an arrangement area for the sub-template is selected on the basis of the position information and the content information.

### BACKGROUND OF THE INVENTION

1. Field of the Invention

The present invention relates to an automatic layout system, and more particularly, to an automatic layout system for dynamically determining a layout of sub-template of content depending on characteristics (such as a level of appeal and a priority) of the content (such as merchandise advertisements) to be laid out.

2. Description of the Related Art

In recent years, life cycles of merchandises have been becoming shorter due to a number of several kinds of merchandises, and also customers have been becoming more customized service oriented along with the spread of the Internet. For this reason, CRM (Customer Relationship Management) and One-to-One marketing have been attracting attentions.

The CRM is intended to manage and utilize customer information to enhance customer satisfaction and increase company's earnings. For example, if a company preliminarily holds information on a purchase pattern, an inquiry history, hobbies, preferences, and the like of some customer, the company can promptly offer a merchandise or service that the customer would like. Also, sharing the customer information among departments or branches of the company can result in the prevention of erroneous treatment of a customer who is treated as a trusted customer in one branch, but as a new customer in the other branch. Thus, it can be considered that managing and utilizing the customer information with use of the CRM result in the enhancement of customer satisfaction in a merchandise or service.

The One-to-One marketing has a marketing concept of grasping the differences in preference, value, job, and living environment of each customer and taking a different sale strategy for each customer to meet each customer needs, and also has a concept and activities similar to those of the CRM. In traditional mass marketing, it is common to assume purchasers that can become new customers, and map out a sale strategy attracting the purchasers based on common items of attributes or common items of purchase tendencies of the purchasers. On the other hand, in the One-to-One marketing, a detailed sale strategy is mapped out for each customer based on the assumption that the each customer is an independent purchasing principal and performs original purchase activities. That is, a sale strategy in the traditional mass marketing is intended to acquire new customers, whereas in the One-to-One marketing, a sale strategy is intended to increase sales while keeping close relationships with existing customers. In order for a company to implement the One-to-One approach, a customer database is required for storing customers' attributes (genders, ages, family constitution, addresses, etc.) and purchasing histories (a list of merchandises having been purchased). Therefore, the company attempting to implement the One-to-One approach installs the customer database, and constantly updates the database, whereby it can provide Web pages, e-mails, and banner advertisements customized for respective customers.

As described above, the One-to-One marketing has a marketing strategy utilizing the customer database. Thus, by accumulating the customer information such as customers' attributes and purchasing histories in the database, and analyzing the accumulated individual information to find customers' needs, and the company can provide merchandises and service meeting the needs.

Examples of the One-to-One marketing can include a variable printing service. The variable printing service is a service providing a different document (printed matter) for each customer. One example of the service is a service providing a different direct mail for each customer. In the variable printing service, pieces of content such as text data and image data representing various merchandises and services are preliminarily stored in a database, and some of the pieces of content read from the database can be printed in the optimal layout.

Also, in a conventional variable printing system, layout frames (also referred to as “containers”) are used to create a layout, and then the layout and a record in a database storing pieces of content are associated with each other. Subsequently, some of the pieces of content are read from the database and inserted into the layout frames. However, in the variable printing system, the layout frames inserted with the some pieces of content are fixed in size. For this reason, if a size of a visual representation of a piece of content data to be inserted into a layout frame is larger than a size of the layout frame, a part of text data may overlap with the other part within the layout frame, or a part of an image data may be lacking. In contrast, if a size of a visual representation of a piece of content data to be inserted into a layout frame is smaller than a size of the layout frame, unnecessary spaces may appear in text data or an image data in the layout frame.

On the other hand, there exists an automatic layout system for automatically varying a font size of a text data and a layout frame size. In the automatic layout system, the layout size can be dynamically varied depending on a visual representation size of content, in order to lay out different pieces of content of size adequately. In this system, to create a layout for a merchandise catalogue or the like, a layout for one merchandise (layout of a name, an image, a specification, etc. of the merchandise) is preliminarily defined as a sub-template, and a conditional expression is used for each customer to extract a merchandise to be laid out. Then, a sub-template corresponding to the merchandise is inserted into a page. Also, if text data of which a visual representation size exceeds a layout frame size is transferred from a database, a font size of the text is reduced to display the entire text within the layout frame. Furthermore, if sizes of a plurality of layout frames are large, the plurality of layout frames are adapted not to overlap on the same document. Still furthermore, one record (one piece of content) in the database can be laid out in one document, and besides, a plurality of records (a plurality of pieces of content, or a multi-record) in the database can also be laid out in one document. By this function, the numbers of pieces of text data and pieces of image data to be laid out can be varied for each document, and thereby a document customized for each customer can be created.

In addition, Japanese Patent Laid-Open No. 2005-216182 discloses a technique for arranging a sub-template of a basic form in a layout area to insert a plurality of similar pieces of data into the predetermined areas in a plurality of pages, and arranging a plurality of layout areas, in each of which the sub-template is arranged.

However, the method for simply arranging the sub-template in the layout area as described in the conventional art can only provide the arrangement of the sub-template of the limited basic form. For this reason, the method can only result in simple layouts in each of which only the sub-template of the same form is arranged repeatedly, and consequently pieces of content to be laid out cannot be weighted. Also, the resulting layout is simple in design. Furthermore, the number of the sub-templates capable of being arranged within the layout area may be limited, and an overall unbalanced layout may be created depending on the number of the sub-templates to be arranged. Still furthermore, the layout area can only be configured in one page, so that the layout area cannot be configured over a plurality of pages. Still furthermore, it is impossible to dynamically create pages on the basis of the number of sub-templates, so that the sub-template cannot be automatically arranged in the layout area arranged over a plurality of pages. Still furthermore, pieces of content are inserted into the layout frames in the order of records stored in a database, so that a layout reflecting levels of importance or appeal of the pieces of content cannot be easily created.

### SUMMARY OF THE INVENTION

The present invention is an automatic layout system for varying a layout of a sub-template for content depending on a size of the content to be laid out on a page. The system includes a module setting an area for flowing the sub-template in the page, a module setting position information in the page, a module setting content information for the content and a module determining the layout of the sub-template according to the position information and the content information.

Also, the present invention is an automatic layout method for varying a layout of a sub-template for content depending on a size of the content to be laid out on a page. The method includes setting an area for flowing the sub-template in the page, setting position information in the page, setting content information for the content and determining the layout of the sub-template on the basis of the position information and the content information.

Furthermore, the present invention is a computer-readable medium having computer-executable instructions to vary a layout of a sub-template for content depending on a size of the content to be laid out on a page. The instructions include setting an area for flowing the sub-template in the page, setting position information in the page, setting content information for the content and determining the layout of the sub-template on the basis of the position information and the content information.

Still furthermore, the present invention is an information processor for varying a layout of content depending on a size of the content to be laid out on a page. The processor includes a setting module setting a characteristic for each area in the page and a processing module laying out the content according to a characteristic of the content and the characteristic of the each area set by the setting module.

Still furthermore, the present invention is an information processing method for varying a layout of content depending on a size of the content to be laid out on a page. The method includes setting a characteristic for each area in the page and laying out the content according to a characteristic of the content and the set characteristic of the each area.

Still furthermore, the present invention is a computer-readable medium having computer-executable instructions to vary a layout of content depending on a size of the content to be laid out on a page. The instructions include setting a characteristic for each area in a page and laying out content according to a characteristic of the content and the set characteristic of the each area.

According to the present invention, in a variable printing system, content of a merchandise or the like (e.g., merchandise advertisement) extracted from a database can be arranged at the optimal position depending on a level of appeal or a priority of the content. Therefore, according to the present invention, content relating to, for example, featured merchandises that a distributor would like to actively sell can be arranged in a prominent area in a page (e.g., upper part of a page). Also, even if the number of pieces of content of a merchandise and the like is large, the content can be arranged in an appropriate area by automatically creating a new page and then rearranging sub-templates.

Further features of the present invention will become apparent from the following description of exemplary embodiments (with reference to the attached drawings)

### BRIEF DESCRIPTION OF THE DRAWINGS

FIG. 1 shows a block diagram illustrating a configuration of a system applied with variable printing;

FIG. 2 shows a block diagram illustrating a configuration of a host computer in the system;

FIG. 3 shows a block diagram illustrating another configuration of the system implementing the variable printing;

FIG. 4 shows a view illustrating one example of a main window 301;

FIG. 5 shows a diagram illustrating conditions of sides of a layout frame;

FIG. 6A shows a diagram illustrating one example of the layout frame;

FIG. 6B shows a diagram illustrating one example of the layout frame;

FIG. 6C shows a diagram illustrating one example of the layout frame;

FIG. 7A shows a diagram illustrating an example of a user interface for setting a link between layout frames;

FIG. 7B shows a diagram illustrating an example of a user interface for setting a link between layout frames;

FIG. 7C shows a diagram illustrating an example of a user interface for setting a link between layout frames;

FIG. 8A shows a flowchart of an outline of layout calculation processing;

FIG. 8B shows a flowchart illustrating a detailed flow of the “layout calculation” in step S703 of the flowchart shown in FIG. 8A;

FIG. 9A shows a diagram illustrating an example of a user interface during the layout calculation;

FIG. 9B shows a diagram illustrating an example of a user interface during the layout calculation;

FIG. 9C shows a diagram illustrating an example of a user interface during the layout calculation;

FIG. 10 shows a diagram illustrating outlines of a multi-record and a method for laying out it;

FIG. 11A shows a flowchart illustrating an outline of an overall operation of this embodiment;

FIG. 11B shows a flowchart illustrating details of a flow layout;

FIG. 12 shows a flowchart illustrating a flow of dynamic flow layout processing;

FIG. 13A shows a flowchart illustrating a flow of an optimal axis selecting process;

FIG. 13B shows a flowchart illustrating a flow of a process for calculating an arrangeable area;

FIG. 14A shows a flowchart illustrating a flow of an arranging process;

FIG. 14B shows a flowchart illustrating a flow of a rearranging process;

FIG. 15 shows a flowchart illustrating a flow of an interrupt process;

FIG. 16 shows a flowchart illustrating post-processing;

FIG. 17A shows a flowchart illustrating a balancing process;

FIG. 17B shows a flowchart illustrating an alignment process;

FIG. 18 shows a view illustrating a display example of a layout window;

FIG. 19 shows a diagram illustrating layout examples of sub-templates;

FIG. 20 shows a flowchart for layout calculation;

FIG. 21 shows a view illustrating an example of a flow area properties dialog box;

FIG. 22 shows a view illustrating an example of an axis properties dialog box;

FIG. 23 shows a view illustrating an example of a layout conditions dialog box;

FIG. 24 shows a view illustrating an example of a balance parameters dialog box;

FIG. 25 shows a basic conceptual diagram for describing a method for arranging sub-templates;

FIG. 26 shows a conceptual diagram illustrating a method for the arranging process;

FIG. 27 shows a conceptual diagram illustrating a method for the rearranging process;

FIG. 28 shows a conceptual diagram illustrating a method for the interrupt process;

FIG. 29 shows a conceptual diagram for describing the process for rearranging a sub-template on the basis of an axis flow direction; and

FIG. 30 shows a conceptual diagram illustrating an alignment method within an axis range.

### DESCRIPTION OF THE EMBODIMENTS

Preferred embodiments applicable with the present invention will hereinafter be described with reference to the drawings.

First, a system configuration and an application configuration applicable with the present invention are described.

### 1. System Configuration

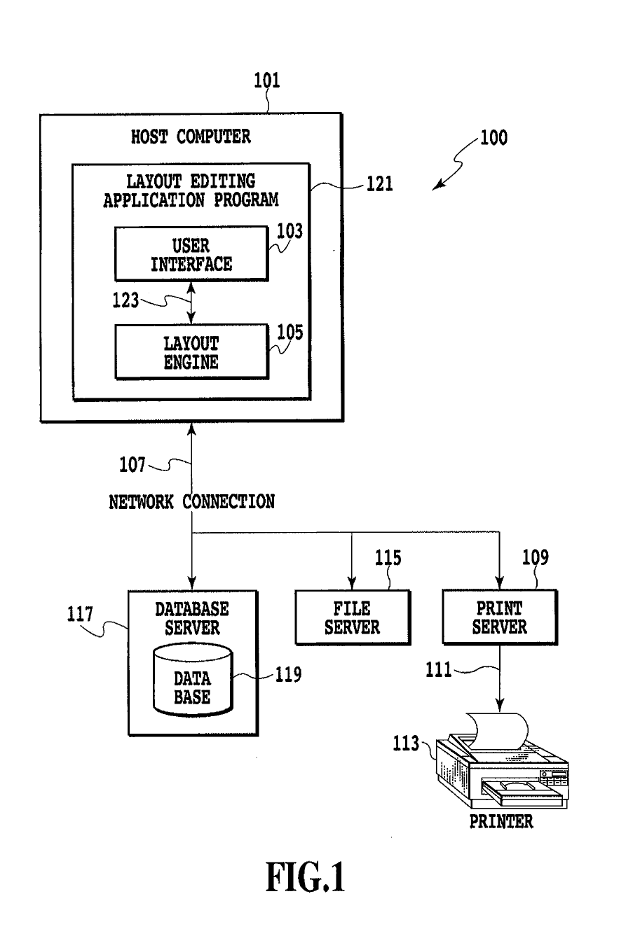

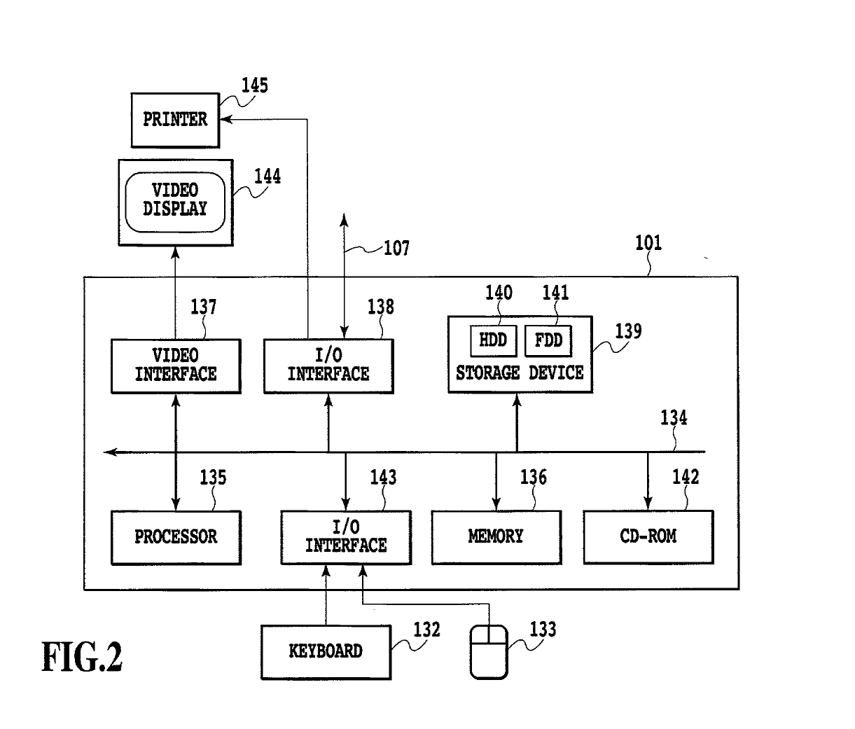

FIG. 1 is a block diagram illustrating a configuration of a system 100 implementing variable printing. FIG. 2 is a block diagram illustrating a configuration of a host computer 101 in the system 100. With reference to both FIGS. 1 and 2, the configurations of the system 100 and the host computer 101 are described.

The host computer 101, which is an information processor, follows instructions of software to perform a layout editing process and a printing process. The software is stored in a storage device 139, which contains computer readable media such as a hard disk and a floppy disk. The host computer 101 reads the software from the storage device 139 and then executes a predetermined process.

The host computer 101 is connected with user input devices such as a keyboard 132 and a pointing device including a mouse 133, and data is input from the devices. Also, the host computer 101 is connected with output devices such as a video display 144 and a local printer 145, and print data, image data, and the like are output to the devices. The host computer 101 performs data communication with other servers through an I/O interface 138 and a network connection 107 such as a local area network (LAN) or a wide area network (WAN). The other servers include a database server 117, a file server 115, and a print server 109.

The host computer 101 comprises at least one processor 135, and a memory 136 such as a volatile memory including a random access memory (RAN) or a nonvolatile memory including a read only memory (ROM). The host computer 101 further comprises a video interface 137 for connecting the video display and an I/O interface 143 for connecting the input devices such as the keyboard 132 and the mouse 133. The storage device 139 is a nonvolatile storage device containing a hard disk drive 140, a floppy disk drive 141, a magnetic tape drive (not shown), a CD-ROM drive 142, and the like.

A layout editing application program 121 according to this embodiment is transferred from the CD-ROM drive 142 or the floppy disk drive 141 to the hard disk drive 140, where it is stored. Then, the processor 135 reads the layout editing application program 121 from the hard disk drive 140, and then executes a predetermined process. In addition, the layout editing application program 121 may be transferred from another server to the hard disk drive 140 through the network connection 107.

Referring to FIG. 1, the layout editing application program 121 comprises a layout engine 105 and a user interface 103. The layout engine 105 is a software component for calculating positions of rectangles and lines according to predetermined restrictions about layout and, layout sizes.

The user interface 103 is a software component for allowing a user to create document templates. The user interface 103 and the layout engine 105 communicate with each other through a communication channel 123.

The database server 117 comprises a database 119. The database 119 stores data sources for creating documents. The host computer 101 communicates with the database server 117 through the network connection 107. The layout editing application program 121 creates the document templates. The document templates are stored in the storage device of the host computer 101 or in the file server 115.

The layout editing application program 121 merges data and a document template with each other to create a document. The storage device of the computer 101 or the file server 115 stores the created document or instructs a printer 113 to print it. The print server 109 is a computer for connecting the printer to the network. The print server 109 and the printer 113 are connected to each other through a communication channel 111.

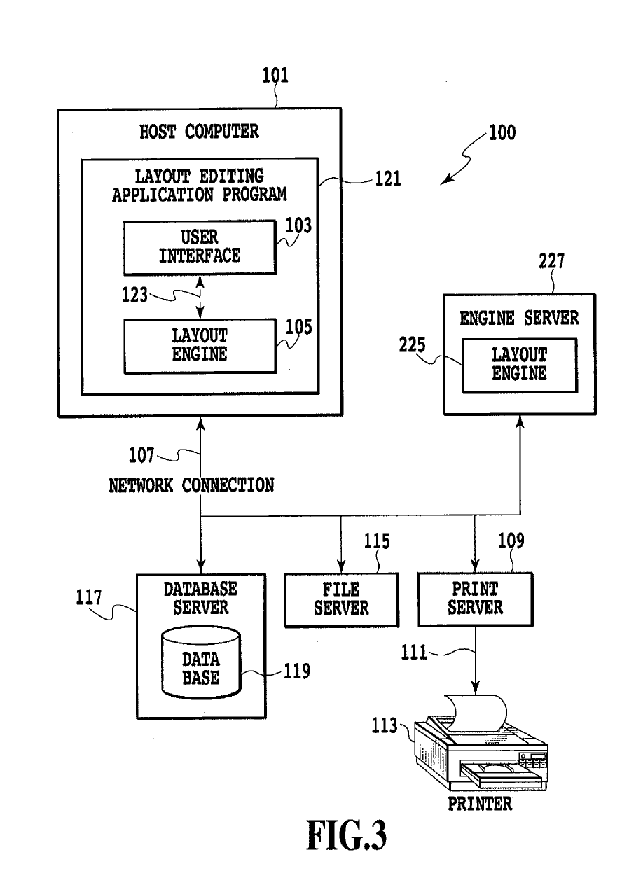

FIG. 3 is a block diagram illustrating another configuration of the system 100 implementing the variable printing.

Different points from the configuration shown in FIG. 1 are that the system 100 in this configuration comprises an engine server 227, and that the layout engine in the previous configuration is separated into the layout engine 105 and a layout engine 225. The layout engine 225 combines a document template stored in the file server 115 and a data source stored in the database 119 to create a document.

### 2. Application Configuration

2-1 Main Window

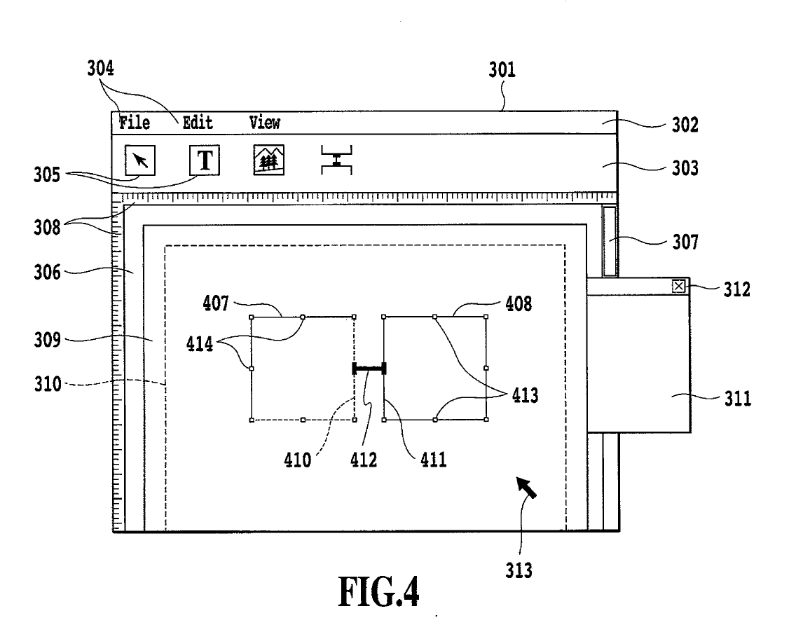

FIG. 4 is a diagram illustrating one example of a main window 301, which is displayed on the video display 144 by the user interface 103 of the host computer 101.

Various user interface elements are displayed in the main window.

Reference numeral 309 represents a document template. The document template 309 of one page includes a plurality of layout frames 407 and 408. The layout frame 407 includes movable sides (dotted lines) 410, and the layout frames 407 and 408 are connected to each other by a link 412.

In the main window 301, there are displayed a menu bar 302, a tool bar 303, a work area 306 movable in conjunction with movement of the pointing device 133 such as a mouse, a floating pallet 311, rulers 308, a cursor pointer 313, and the like.

In addition, the menu bar is a bar on which a list of selectable on-screen functions is displayed, and the tool bar is a kind of menu on which icons for promptly operating frequently-used functions are arranged. Also, the floating pallet has a function of separating several types of icons assigned with frequently-used tools and choices from an application window and displaying them as another independent window, which is placed on a desktop screen. Furthermore, the ruler is a kind of tool bar with a scale, which is displayed outside an area for displaying a document indication part in word processing software, software providing DTP features, or the like.

The rulers 308 show positions of the pointer, page, line, margin guide, layout frame, or object in the work area 306 with use of the scales.

The floating pallet 311 is used to access additional functions such as libraries, and has a window control 312 for moving, resizing, or closing the pallet itself.

On the tool bar 303, there are displayed icons 305, and with use of any of the icons, “display” or “non-display” can be selected. The tool bar 303 comprises a selection tool button, an image data layout frame tool button, a text data layout frame tool button, a link tool button, and the like. The selection tool button is a button for selecting, moving, resizing, locking, or unlocking of a layout frame. A plurality of layout frames may be selected by dragging selection boxes around the plurality of layout frames, or by keeping pushing a CTRL key. The image data layout frame tool button is a button used for creating a layout frame into which a static image or a variable image is to be inserted. The text data layout frame tool button is a button used for creating a layout frame into which a static text or a variable text is to be inserted. The link tool button is a button used for controlling a distance between layout frames.

2-2 Document Template

The work area 306 is an area for displaying or editing a design of the document template 309. By viewing the work area 306, a user can design an outline of a document, or visually grasp how a merged document varies on the basis of a size of variable data.

The document template 309 can show that there exist a plurality of pages in the document template.

The user can specify a size of the page in the document template 309. The actual number of pages in the document template maybe varied on the basis of a size of variable data. If a visual representation size of the variable data exceeds the size of the page, an additional page is automatically created.

A borderline of each page is represented by a page margin 310. The page margin 310 indicates the maximum width of a printable object in the page.

2-3 Layout Frame

The layout frame 407 or 408 is a fixed-sized or variable-sized space in the document template 309. Into this space, text data or image data are inserted. Also, the layout frame is arranged while interacting with other layout frames and objects. Furthermore, the layout frame can be moved, resized, or recreated with use of the pointing device 313.

The layout frame has a collection of setting information, and also comprises functions of visual representation, interaction, and editing operation. Definitions of the layout frame are described below.

(1) The layout frame is fixed-sized or variable-sized. Variable content is dynamic in that it may be different for different documents. Also, time-varying content such as animation is not adapted for printing, so that content such as variable content is not assumed in this embodiment. On the other hand, in the case of fixed content, the same information is displayed in all documents. However, the fixed content is variable in its arrangement position because it is affected by the arrangement of a variable layout frame.

(2) The layout frame has decoration functions for setting a background color, a borderline, a font style, and the like of a visual representation of content.

(3) The layout frame is merged with data obtained from a data source, and then the merged frame is displayed on the video display 144 or printed by the printer 133.

(4) The layout frame has the interactive user interface 103 for editing or display settings of the layout frame. Elements of the user interface 103 are displayed on the video display 144, but not printed in a document. The user interface 103 shows the decoration functions for the layout frame, such as settings of a background color and a font, and also the interface elements for editing or displaying the settings of the layout frame.

2-4 Restrictions on Layout Frame

The layout frame is subjected to restrictions in terms of how to associate a piece of content displayed in each document with the layout frame. The restrictions are set by a user. The restrictions include, for example, “Content is displayed up to 4 inches in height within the layout frame”, and “Content is displayed within the layout frame such that a left edge of the display area for the content is in the same horizontal position in all documents”. The user sets such restrictions with use of the user interface 103.

A content place holder for specifying an arrangement of fixed content has information on a position and a size of the layout frame, which are edited by publicly-known means and displayed.

The user can set a size and a position of a content representation area in a document with respect to the layout frame. A large number of document layouts can be created on the basis of one document template 309, that is, the layout frame is utilized as a user interface for specifying/displaying large numbers of layout possibilities and restrictions.

2-5 Method for Creating Layout Frame

There are two types of layout frames, i.e., a text data layout frame and an image data layout frame. The text data layout frame contains fixed text data, or variable text data received from the database 119. On the other hand, the image data layout frame contains embedded image data, or variable image data received from the database 119.

Referring to FIG. 4, the text data layout frame or the image data layout frame can be selected by clicking the widget 305 with the mouse 133. The selected text data layout frame or image data layout frame is created in the document template 309.

In addition, the widget is an application (or an element) in which a graphic symbol such as a scroll bar or a button and a program code for fulfilling a specific function are integrated with each other in a graphical user interface. The layout frame may also be created by simply activating a similar tool to the widget and clicking the mouse 133 in the document template 309. In this case, creating a default sized layout frame in the document template 309, or displaying a dialog box allows the user to specify a size of a new layout frame and create a layout frame with the specified size.

2-6 Method for Displaying Layout Frame

Referring to FIG. 4, sides of a layout frame represent a virtual borderline for displaying content in a document. For example, a left side of the layout frame is treated as the leftmost side inside which content associated with the layout frame can be constantly displayed. Similarly, a height of the layout frame is treated as the maximum height within which content associated with the layout frame can be constantly displayed. In this embodiment, the user interface 103 can be used to vary the sides or height of the layout frame, i.e., a size of the layout frame.

The following describes rules used for constraining a content layout. The rules define a relationship between the user interface and the layout.

If right and left sides of a layout frame are represented by solid lines, a width of the layout frame is fixed, and a width assigned to an area for displaying content associated with the layout frame is common in all documents. On the other hand, if the right and left sides of the layout frame are represented by dotted lines, a height of the layout frame is variable.

If upper and lower sides of the layout frame are represented by solid lines, the height of the layout frame is fixed, and a height assigned to the area for displaying the content associated with the layout frame is common in all documents.

The term “variable” means that a side, a position, or a document restriction may vary for each document. The following describes examples of rules for the relationship for implementing the “variable” between the user interface and the layout.

If the right and left sides of the layout frame are represented by dotted lines, the width of the layout frame is variable, and the width assigned to the area for displaying the content associated with the layout frame varies for each document.

If the upper and lower sides of the layout frame are represented by dotted lines, the height of the layout frame is variable, and the height assigned to the area for displaying the content associated with the layout frame varies for each document.

If a restriction on a distance between layout frames is variable, a specified distance may vary for each document. Settings of the restriction on the distance enable a user to adjust the distance between the layout frames within the limits of the maximum and minimum distances.

If the layout frame restrictions are applied to a dotted line side of the layout frame, the layout frame may extrude another layout frame connected to the layout frame due to the restrictions and change in position. The restriction on upper and lower sides results in a longitudinal change in position, and that on right and left sides results in a lateral change in position.

If a solid line side of the layout frame is connected with another layout frame, the another layout frame may be extruded by the layout frame due to the restrictions, and change in position. The restriction on upper and lower sides results in a longitudinal change in position, and that on right and left sides results in a lateral change in position. If the restriction on a distance between layout frames is fixed, a specified distance is common in all documents.

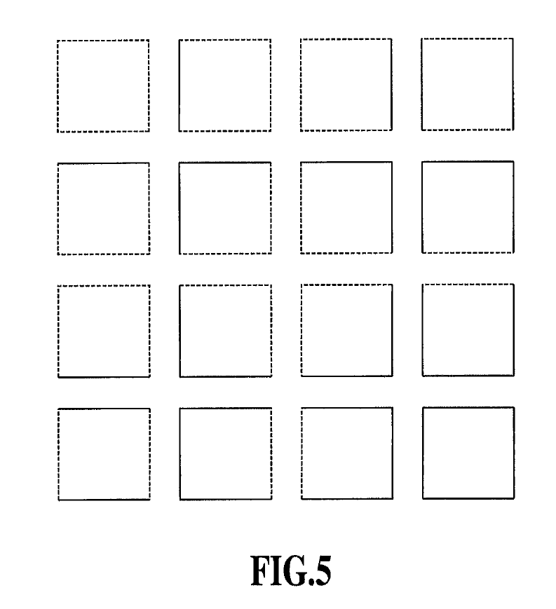

FIG. 5 shows conditions of sides of a layout frame. Referring to the diagram, there are shown 16 types of layout frames, from a layout frame having upper, lower, right and left sides represented by dotted lines to that having upper, lower, right and left sides represented by solid lines. In general, such side condition of a layout frame is an element shown as a support to a design of the document template 309, so that it is not shown in printed matter.

Minimum and maximum setting values of a width and a height, which are set as the layout frame restrictions, are displayed in the secondary dialog window 311.

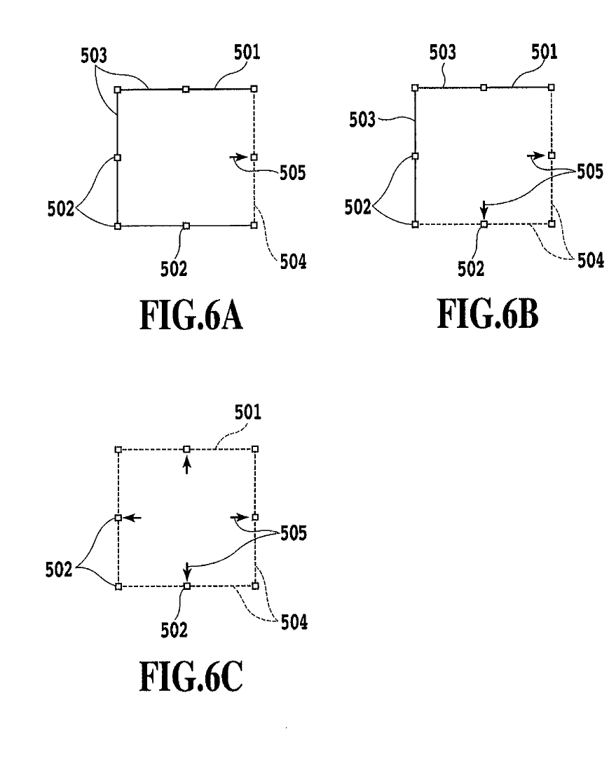

FIG. 6 is a diagram illustrating display examples of a layout frame.

In FIG. 6A, a layout frame 501 is variable in width. In this case, sides 503 are fixed, and therefore represented by solid lines, whereas a side 504 is variable, and therefore represented by a dotted line. Reference numeral 505 represents a scaling icon. The scaling icon 505 indicates that the side 504 is variable. In FIG. 6B or C, it turns out that the layout frame 501 is variable in both width and height.

2-7 Method for Setting Link

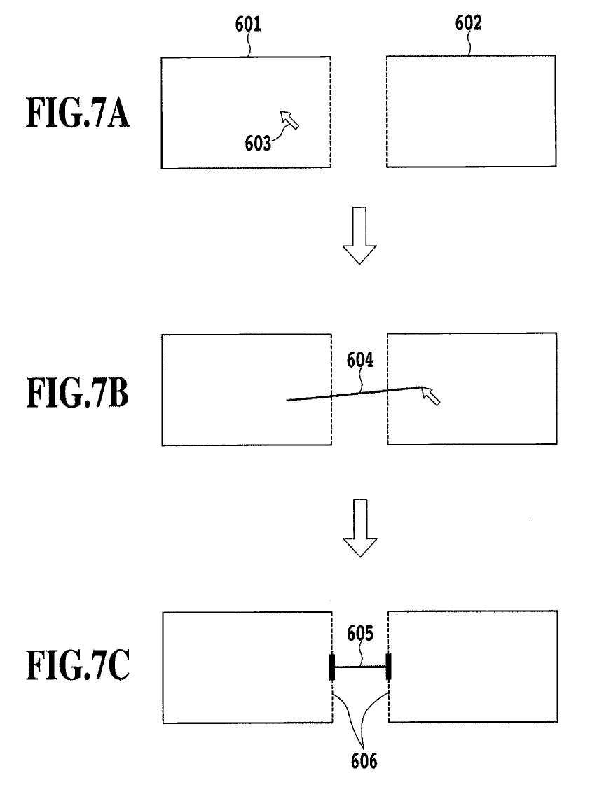

FIGS. 7A, B and C show an example of a user interface for setting a link between layout frames.

To set a link, it is necessary to create at least two layout frames. The diagrams show an example in which a link is set between two layout frames.

A setting procedure of the link is described in the order of FIGS. 7A, B, and C.

Reference numerals 601 and 602 in FIG. 7A represent fixed sides, which are identical to the sides indicated by Reference numeral 503 in FIG. 6. Reference numeral 603 represents a mouse pointer. First, select one layout frame 601 to be set with the link, with use of the mouse pointer 603, and click a mouse. Then, move the mouse pointer 603 to the other layout frame 602 as shown in FIG. 7B, and click the mouse again. Reference numeral 604 in FIG. 7B represents a line connecting between the layout frames 601 and 602 with use of the mouse pointer, and shows a user any layout frames connected by the link. Click the layout frame 602 with the mouse on the screen shown in FIG. 7B, and then the link (connecting line 605) connecting between the layout frames 601 and 602 is created as shown in FIG. 7C.

Sides 606 in FIG. 7C are drawn as dotted lines, and therefore variable. Accordingly, a width of the layout frame 601 can be expanded in the right direction. Contrarily, a width of the layout frame 601 can be expanded in the left direction. Also, a right side of the layout frame 601 and a left side of the layout frame 602 are connected to each other by the link, so that sizes of the layout frames can be variably controlled while a distance therebetween is kept constant.

2-8 Layout Calculation Processing

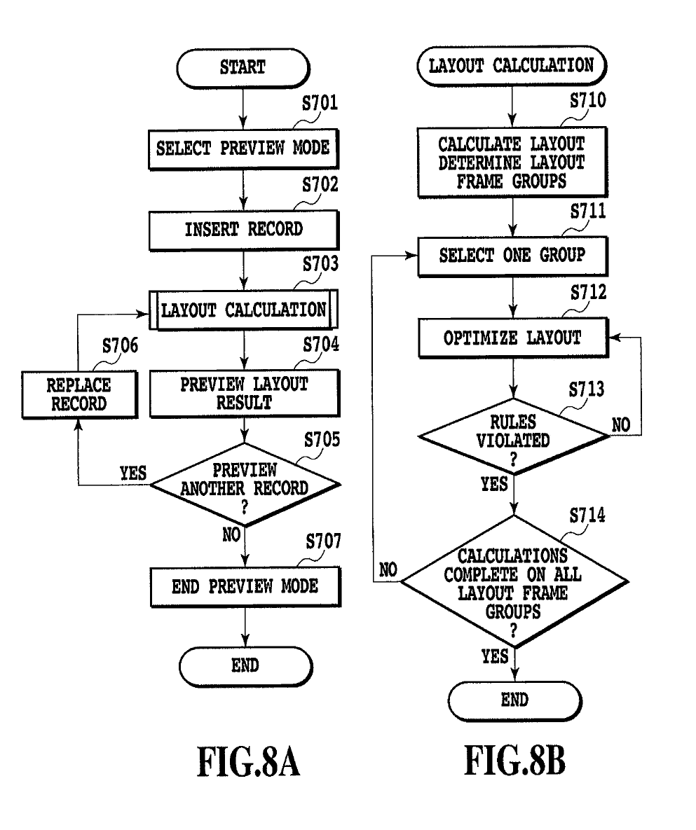

FIG. 8A is a flowchart for layout calculation processing.

The user selects a preview mode (S701). An automatic layout system creates layout frames, and associates the layout frames with each other. Also, the system comprises a layout mode for creating a layout. Furthermore, the automatic layout system comprises the preview mode for previewing a result of the layout in which records (pieces of content) in a database are actually inserted into the created layout frames. In the preview mode, the actual records (pieces of content) are inserted into a window frame, and the layout is calculated. In the preview mode, the layout is calculated for the case where the layout is displayed on a screen; however, even for the case where the layout is printed, the same procedure is taken to calculate the layout.

When the preview mode appears, a record (piece of content) to be previewed is selected and then inserted (S702). When the record (piece of content) is inserted, a calculation is performed to lay out the record (piece of content) (S703) Then, a result of the layout calculated in step S703 is previewed (S704). Subsequently, it is determined whether or not another record (piece of content) is previewed, according to a user input. (S705). If it is determined in step S705 that it is not necessary to preview another record (piece of content), the preview mode is ended (S707). In contrast, if another record (piece of content) is previewed, another record (piece of content) is selected, then a layout is again calculated, and the calculated layout is previewed (S706). On the other hand, if the records (pieces of content) are printed, layout calculations are performed sequentially for all records (pieces of content) to be printed, and all the records (pieces of content) are printed.

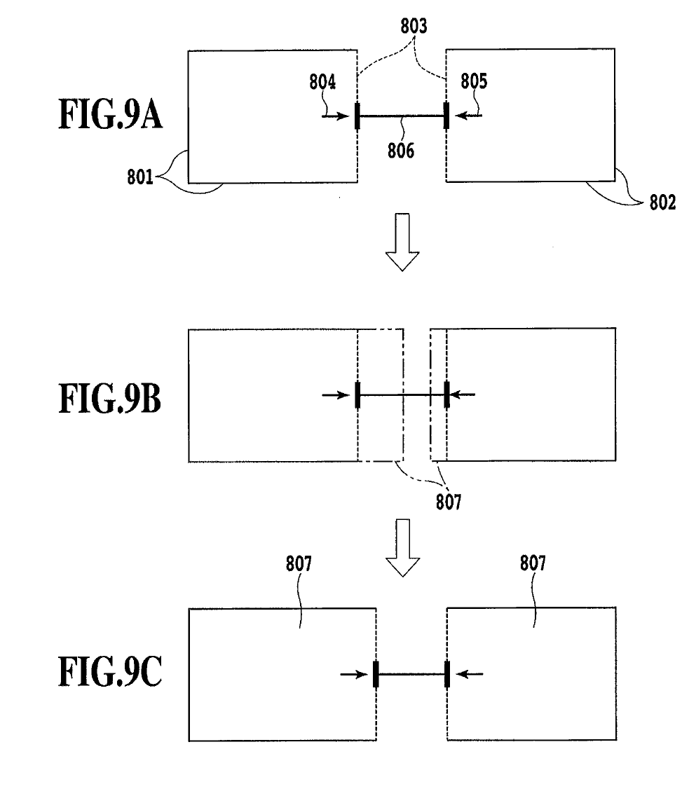

FIG. 8B is a flowchart illustrating a detailed flow of the “layout calculation” in step S703 of the flowchart shown in FIG. 8A. Also, FIGS. 9A, B, and C are diagrams illustrating a display example on the screen during the layout calculation.

Referring to FIG. 8B, groups of layout frames of which a layout is to be calculated are determined (S710). The layout calculation is performed, assuming a group of layout frames associated with each other by a link, as one unit. Then, one group is selected from the groups of layout frames determined in step S710, to perform the layout calculation (S711). Subsequently, the layout calculation is performed on the selected group of layout frames. During the calculation, the layout is optimized such that the difference between a size of each of the layout frames and a size of an area for actually displaying each piece of content is minimized (S712). Subsequently, it is determined whether or not a result of the layout optimization violates rules (S713). If the layout optimization result violates the rules, the layout is again optimized to obtain a result that does not violate the rules (S712). Note that the rules mean restrictions a user sets in order to create the layout, and include, for example, rules for sizes and positions of layout frames, conditions of sides, and lengths of links. Subsequently, it is determined whether or not the calculation has been performed on the group of layout frames (S714), and if it has been already performed, the layout calculation processing is ended. By performing the above steps S711 to S713 on all of the groups in a page, the entire page layout is calculated.

FIGS. 9A to C show an example of the user interface during the layout calculation.

FIG. 9A shows a condition where certain records (pieces of content) are inserted and a layout is determined. Reference numerals 801 and 802 indicate fixed sides, 803 variable sides, 804 and 805 directions in which the variable sides move respectively, and 806 a link. In this condition, the records (pieces of content) are replaced by other records and visual representation sizes of the pieces of content are varied.

FIG. 9B shows a condition where other-sized content areas overlap with the condition shown in FIG. 9A. Reference numeral 807 indicates the sizes of the content areas to be inserted into the respective layout frames. FIG. 9C shows a layout calculation result. The layout calculation is performed such that a ratio between an area of each of the layout frames after the calculation and the content area to be actually inserted into the corresponding layout frame is equalized and also the above described rules are not violated. As shown in FIG. 9C, the ratio between each of the content areas (807) to be inserted shown in FIG. 9B and the corresponding content area (808) after the calculation is equalized for both of the layout frames.

2-9 Multi-Record

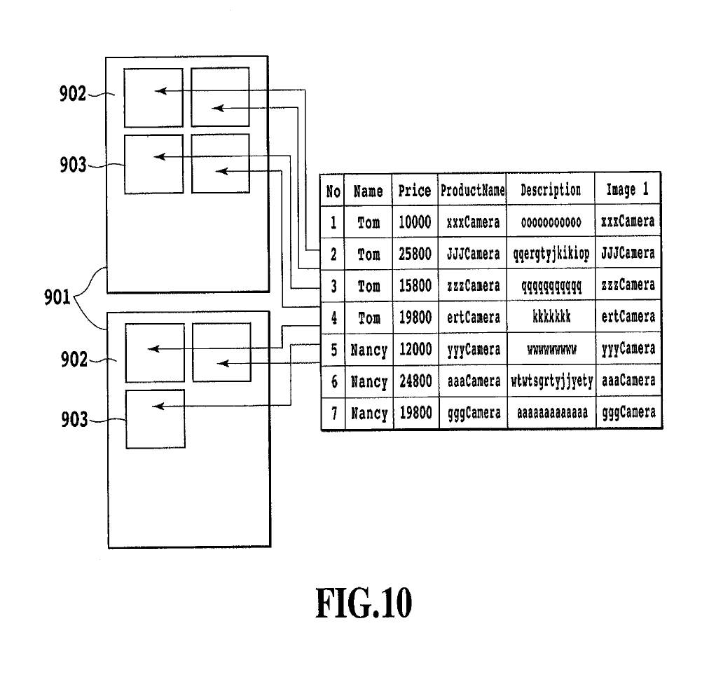

FIG. 10 is a diagram illustrating outlines of a multi-record and a method for laying out it.

Reference numeral 901 indicates a document, 902 pages (first page and second page) constituting the document, 903 sub-templates, and 904 records (pieces of content) stored in a database. There are 7 records (pieces of content) named Nos. 1 to 7 in the records 904. Each of the records stores respective pieces of data on name, price, merchandise name, detail, and image.

Accordingly, if variable printing is performed under the condition of 1 page per 1 record, 7 pages will be created; however, in variable printing supporting a multi-record indicating 1 page per 1 multi-record as in this example, the following process is performed.

First, a user arbitrarily specifies a column assigning a multi-record. For example, assume that the user specifies “Name” as the column. In this case, records (pieces of content) of which names in the specified “Name” column are identical are laid out on the same page. In this example, the records of Nos. 1 to 4 have the same name “Tom” in the “Name” column, and therefore the records about “Tom” are laid out on the first page. On the other hand, the records (pieces of content) of Nos. 5 to 7 have the same name “Nancy” in the “Name” column, and therefore laid out on the second page. Such procedure is employed for a typical multi-record (content).

2-10 Sub-Template

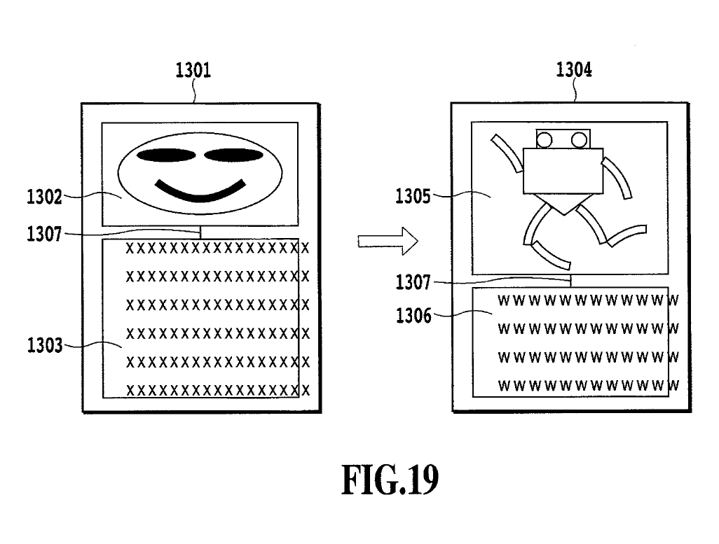

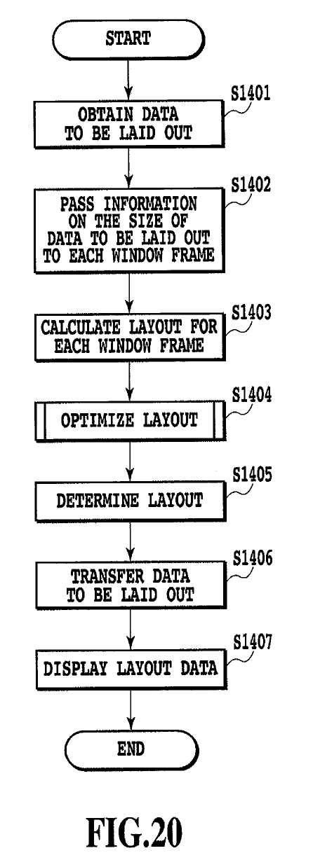

An outline of the sub-template and a layout flow are described. FIGS. 19 and 20 show layout examples of sub-templates and one example of a layout flow, respectively.

The sub-template is arranged with arbitrary numbers of image data layout frames and text data layout frames. Which field data in a record (a piece of content) is assigned to which of the layout frames is configured.

The sub-template is convenient if the same layout is repeatedly used for one document. The layout frames arranged in the sub-template include the image data layout frames and the text data layout frames, and a link can be set between respective layout frames. Accordingly, sizes of layout frames can be optimally varied, depending on pieces of data to be laid out.

FIG. 19 shows the layout examples of sub-templates. Reference numerals 1302 and 1305 represent image data layout frames, 1303 and 1306 text data layout frames, and 1307 links. A content size of image data and that of text data are different from each other, so that an optimal layout is calculated for the different records (pieces of content) and a layout is changed.

FIG. 20 is a diagram illustrating a flowchart for the layout calculation.

First, pieces of data to be laid out are obtained (S1401). Then, information on sizes of the pieces of data to be laid out is passed to respective layout frames (S1402). Subsequently, the layout calculations are performed for the respective layout frames on the basis of the passed data sizes (S1403). Subsequently, the layout is optimized (S1404). A method for optimizing the layout is performed in the same manner as described above. After that, the optimized layout is determined (S1405), into which the pieces of data to be laid out are transferred from a database (S1406), and eventually displayed (S1407).

### 3. Embodiment

The embodiment of the present invention is described in detail with reference to the drawings.

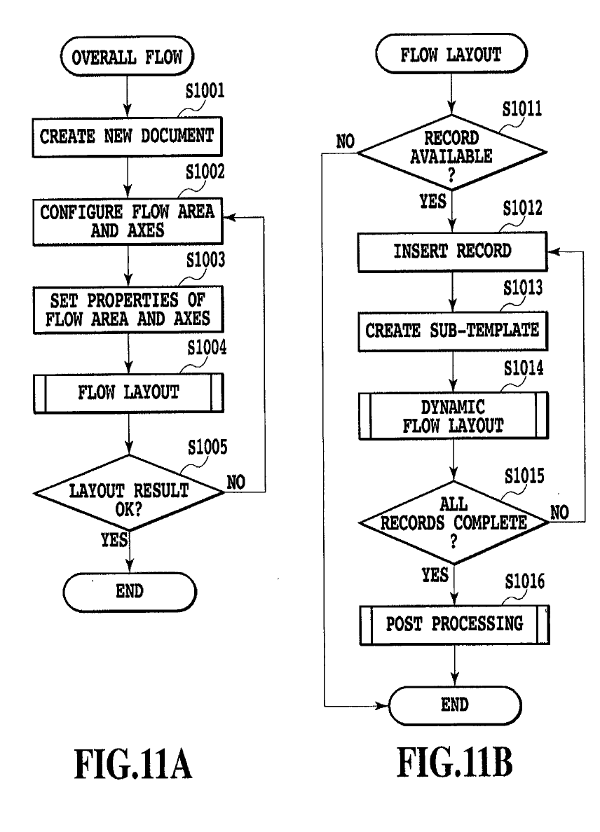

FIGS. 11 to 18, and 21 to 24 are flowcharts for describing operations of this embodiment, and diagrams illustrating associated user interfaces, respectively. With reference to these diagrams, this embodiment is described.

FIG. 11A is a flowchart illustrating the overall operation of this embodiment.

First, in step S1001, a user connects to a database to create document newly.

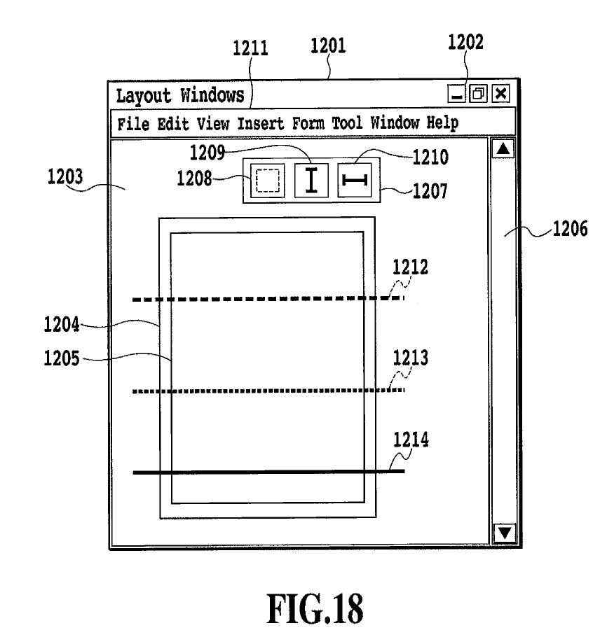

After the connection to the database, the user configures a flow area and axes in a document page (S1002). FIG. 18 shows a flow area 1205 and axes 1212, 1213 and 1214 displayed in a layout window 1201. The flow area 1205 is an area in which sub-templates are arranged, and created in a page area. Reference numeral 1202 indicates a tool for minimizing, maximizing, or closing the layout window. Reference numeral 1203 represents a layout area. The user uses layout frames to arrange text data, image data, graphics, and the like in the layout area 1203. Reference numeral 1204 represents the page area selected in a document. The flow area 1205 can be created by using a flow area creating tool 1208 in a tool bar 1207 area to drag and drop with a mouse.

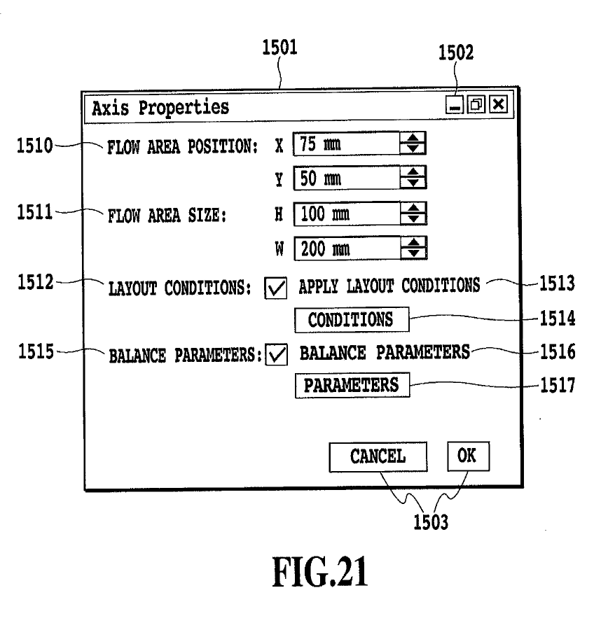

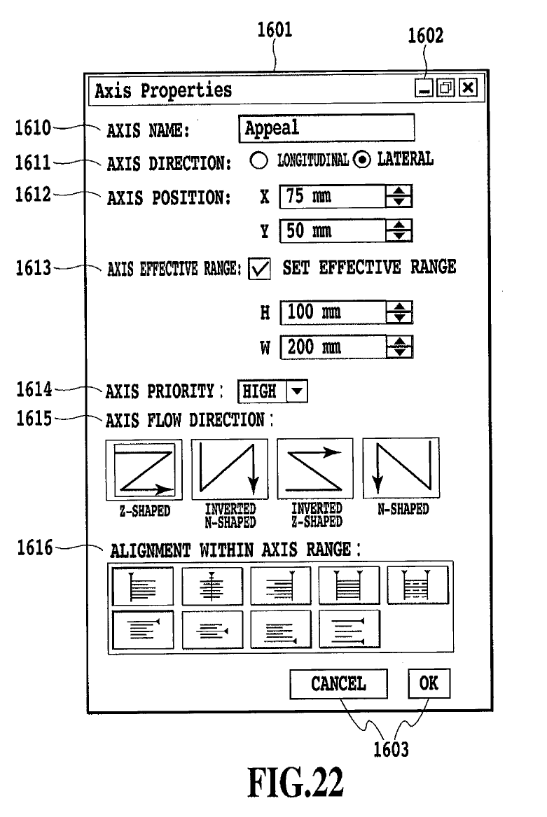

Properties of the flow area 1205 can be set by displaying a flow area properties dialog box 1501 shown in FIG. 21 through a menu command 1211 in the layout window 1201 (S1003). After the creation of the flow area 1205, the user creates the axes 1212, 1213 and 1214. To arrange various sub-templates in the flow area, arrangement positions are determined with reference to properties (e.g., properties of bargain merchandises) of pieces of content and the axes. A plurality of axes can be created, and both a lateral axis and a longitudinal axis can also be created. The axes can be created by using an axis creating tool 1209 or 1210 in the tool bar 1207 area to drag and drop with the mouse, similarly to the flow area. The created axes are referenced as position information in a page when sub-templates are arranged. Reference numerals 1209 represent the tools for creating a lateral axis and a longitudinal axis 1210, respectively. Also, axis properties can be set by displaying an axis properties dialog box 1601 shown in FIG. 22 through the menu command 1211 in the layout window 1201 (S1003). In the layout window 1201 shown in FIG. 18, the three axes 1212, 1213 and 1214 are created in the lateral direction. To easily distinguish these axes, the respective axes can be color-coded. The color-coding may be automatically set by a program, or set by the user him-/herself.

After the configuration of the flow area and the axes in step S1002 of FIG. 11A, properties of the flow area and the axes are set (S1003). The properties can be set by mouse operations on the flow area 1205 and the axes 1212 to 1214 displayed in the layout area 1203 in FIG. 18, or by displaying the properties dialog boxes through the menu command 1211.

After the settings of the flow area and the axes, a flow layout is performed (S1004).

FIG. 11B is a flowchart illustrating details of the flow layout in step S1004. In step S1011, it is determined whether or not there is any record to be inserted, and then if there is a record, the record is inserted (S1012). Subsequently, sub-templates are created (S1013), and then an after-mentioned dynamic flow layout is performed (S1014). After that, it is determined whether or not all records have already been processed (S1015), and if they have already been processed, after-mentioned post processing is performed (S1016).

FIG. 21 shows an example of the flow area properties dialog box. This box can be used to set a flow area position, a flow area size, layout conditions, and balance parameters. In step S1004, the sub-templates are arranged in the flow area according to settings of the flow area position 1510, the flow area size 1511, the layout conditions 1512, the balance condition 1515, and the like, and if necessary, an additional page is created. Subsequently, the flow layout is performed (S1004), then it is determined whether or not the layout result is OK, and if it is OK, the flow layout is ended, whereas if it is not OK, the operation returns to step S1002 where the flow area and the axes are reconfigured.

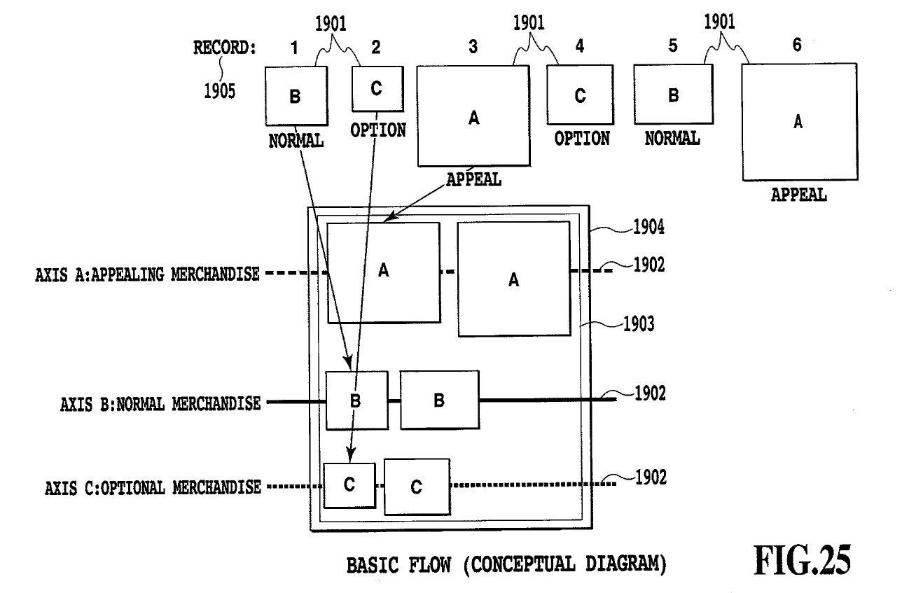

FIG. 25 is a basic conceptual diagram for describing a method for arranging sub-templates.

Reference numeral 1901 indicates various sub-templates. Sub-templates A indicated by records 3 and 6 contain content (e.g., relating to featured merchandises) that an advertiser would like to actively sell. Also, sub-templates B indicated by records 1 and 5 contain normal content. Furthermore, sub-templates C indicated by records 2 and 4 contain optional content.

Reference numerals 1903 and 1904 represent a flow area and a page, respectively. Also, Reference numeral 1905 indicates record numbers. The flow layout is performed in such a way that the sub-templates are arranged in the order of the records in the database. The records in the database may be sorted or filtered. Reference numeral 1902 indicates 3 axes. The sub-templates are allocated to corresponding axes for arrangement. The sub-templates indicated by the records 1, 2, 3, 4, 5 and 6 are allocated to the axes B, C, A, C, B, and A, respectively.

A procedure for allocating the sub-templates to the axes is now described in more detail.

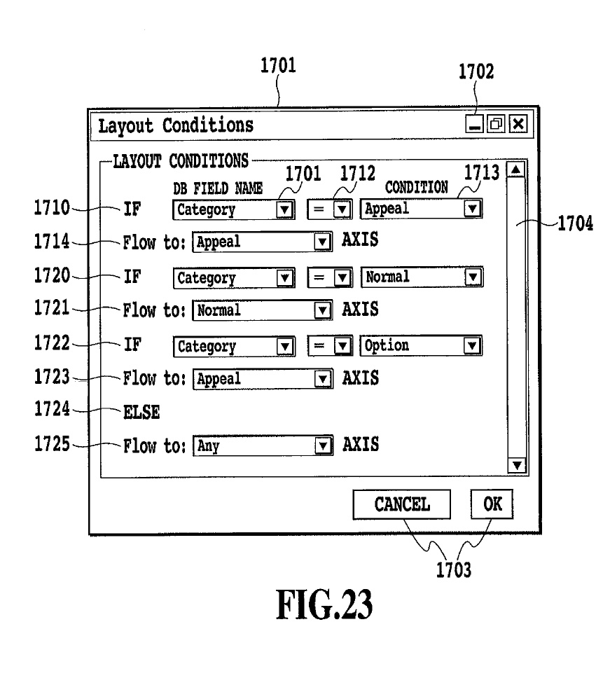

FIG. 23 is a diagram illustrating one example of a layout conditions dialog box.

Reference numeral 1702 indicates a button for minimizing, maximizing, or closing the layout conditions dialog box. Reference numeral 1703 represents buttons for choosing to either apply or cancel the properties (conditions) input in the dialog box. Reference numeral 1704 represents a scroll bar in the dialog box. If a size of content data to be displayed is large, this scroll bar may be used to scroll a viewing area.

In the layout conditions dialog box, it is determined which sub-template is allocated to which axis. The layout conditions can be set, like, for example, “If data in a DB field relates to an advertisement for an appealing merchandise, a sub-template is allocated to an appeal axis (e.g., axis 1212). Also, if it relates to an advertisement for a normal merchandise, a sub-template is allocated to a normal axis (e.g., axis 1213). Furthermore, if it relates to an advertisement for an optional merchandise, a sub-template is allocated to an option axis (e.g., axis 1214).” The reason why the sub-templates are allocated in this manner is that by allocating the appealing merchandise to the appeal axis positioned in the upper area in a page that attracts customers' attention, the advertisement for the appealing merchandise can easily catch customers' eyes.

It is also possible to set the conditions, like, for example, “If data in the DB field relates to ◯◯××, a sub-template is allocated to an axis Δ, in other case, a sub-template is allocated to an axis ⋄”. “DB field name” indicated by Reference numeral 1711 corresponds to the above-described “DB field”, in which a DB field for determining an axis to which a sub-template is allocated is set. Reference numeral 1712 indicates “=”; however, another mathematical symbol such as “>” or “<”, or a conditional statement such as “including” or “from” may be used. “Condition” indicated by Reference numeral 1713 corresponds the above-described “data in the DB field relates to ◯◯××”. For the “Condition”, data itself used for a determination condition is set. “Flow to:” indicated by Reference numeral 1714 corresponds to the above-described “allocated to”. “Axis” indicated by Reference numeral 1715 corresponds to the above-described “axis Δ”, and sub-templates meeting the above layout condition are allocated to an axis specified for the “Axis”. Reference numeral 1725 represents an item corresponding to the above-described “allocated to an axis ∇”, which is a combination of the descriptions of Reference numerals 1714 and 1715. “‘Any’ axis” indicated by Reference numeral 1725 represents a setting meaning that a sub-template may be allocated to any axis if the axis has an empty space thereon during layout. Also, in this properties dialog box, by creating a plurality of “IF” statements as indicated by Reference numerals 1720 to 1723, a plurality of conditional expressions can be created. Accordingly, in this example, if the DB field name “Category” is “Appeal”, relevant sub-templates are allocated to the “Appeal” axis. Also, if the DB field name “Category” is “Normal”, relevant sub-templates are allocated to the “Normal” axis. Furthermore, if the DB field name “Category” is “Option”, relevant sub-templates are allocated to the “Option” axis. In cases other than the foregoing cases, there is applied a setting indicating that a sub-template is arranged in the empty space during layout.

That is, in this embodiment, content characteristic information indicating a level of appeal and priority is first added to a record in the database. Then, the record is read from the database, and arranged in a page as a sub-template such that it is allocated to a position (axis) corresponding to the content characteristic information. Thus, according to this embodiment, an advertisement for a merchandise that desirably attracts customers' attention can be arranged in the most prominent area in the page, for example.

FIG. 21 shows one example of the flow area properties dialog box. Reference numeral 1502 indicates a button for minimizing, maximizing, or closing the flow area properties dialog box. Reference numeral 1503 represents buttons for choosing to either apply or cancel the properties input in the dialog box. Reference numeral 1510 represents a box for setting a position of the flow area. X represents a lateral position of a starting point of the flow area, and Y a longitudinal position of the starting point of the flow area. In other words, the coordinates (X, Y) represent the starting point of the flow area. The coordinates are typically set at an upper left corner of the flow area. Reference numeral 1511 represents a box for setting a size of the flow area. H represents a height of the flow area, and W a width of the flow area. Accordingly, values specified by the H (HEIGHT) and W (WIDTH) represent the flow area size. An area from the starting point set for the flow area position setting 1510 to a point shifted from the starting point by the H value in the longitudinal direction and to a point shifted from the starting point by the W value in the lateral direction defines a range of the flow area. Reference numeral 1512 represents a box for setting the layout conditions for the flow area. Reference numeral 1513 represents a checkbox for choosing to either apply (use) or not apply the flow area layout conditions. If the checkbox is ticked, the layout conditions are applied, whereas if the box is unchecked, the layout conditions are not applied. A flow for setting the layout conditions is described later.

Reference numeral 1515 represents a checkbox for choosing to either apply or not apply the balance parameters for a layout in the flow area. If the checkbox is ticked, the balance parameters are applied, whereas if the box is unchecked, the balance parameters are not applied. A flow for setting the balance parameters is described later.

FIG. 22 shows one example of the axis properties dialog box.

Reference numeral 1602 indicates a button for minimizing, maximizing, or closing the axis properties dialog box. Reference numeral 1603 represents buttons for choosing to either apply or cancel the properties input in the dialog box. In the item indicated by Reference numeral 1610, an axis name is set with use of arbitrary character string. The name (e.g., Appeal) is used in the layout conditions dialog box shown in FIG. 23. In the item indicated by Reference numeral 1611, an axis direction is set. “Longitudinal” represents an axis extending in the longitudinal direction with respect to the page, and “Lateral” an axis extending in the lateral direction with respect to the page. A direction of each axis is set to either the longitudinal direction or the lateral direction. In the item indicated by Reference numeral 1612, coordinates of a starting point of an axis are set. X represents a lateral position of the starting point of the axis, and Y a longitudinal position of the starting point of the axis. In other words, the coordinates (X, Y) represent the starting point of the axis. If “Longitudinal” is chosen as the axis direction in the item 1611, an input box for Y is grayed out, whereas if “Lateral” is chosen, an input box for X is grayed out. This is because a longitudinal axis does not have any constant value for the longitudinal direction, and also a lateral axis does not have any constant value for the lateral direction. In the item indicated by Reference numeral 1613, an effective range of an axis is set. The effective range of an axis means a range within which a sub-template may be arranged near the axis depending on the layout conditions. That is, the sub-template does not have to be arranged on the axis if it is within the effective range of the axis. Accordingly, the sub-template is freely arranged within an appropriate range or an allowable range with respect to the axis. If the axis is lateral, a range in height is longitudinally symmetric with respect to the center of the axis, and a range in width is laterally symmetric with respect to the center of a lateral width of the page. If the effective range of an axis is not set, the effective range of the axis becomes the entire page. In addition, in such a case, the axis can be arranged at any position, and therefore it is difficult to arrange a sub-template at an appropriate position.

In the item indicated by Reference numeral 1614, a priority of an axis can be set. That is, if a plurality of axes are required, a priority of an axis to which a sub-template is allocated can be chosen. If a certain axis has a higher priority than other axes, a sub-template meeting conditions for allocating to the higher-priority axis may need to be allocated to the axis. In such a case, even if other sub-templates have already been allocated to the higher-priority axis, the other sub-templates can be cleared once to arrange the intended sub-template in the effective range of the axis. The other sub-templates once cleared are arranged in another area.

In this embodiment, “High”, “Medium”, or “Low” can be set as the axis priority. It should be appreciated that a type of the setting may be increased in number, or an absolute order may be set.

In the item indicated by Reference numeral 1615, a flow direction within an axis range can be set. Various flow directions are possible, including, but not limited to, a Z-shaped direction from upper left to lower right and an inverted N-shaped direction from upper left to lower right as shown in FIG. 22. When sub-templates are allocated to axes, an already-set flow direction is applied to the sub-templates to flow them. In the item indicated by Reference numeral 1616, an alignment method within an axis range can be set. The alignment method is applied to sub-templates, and after arrangement of sub-templates, the sub-templates can be aligned, such as flush top, flush bottom, flush right, and flush left.

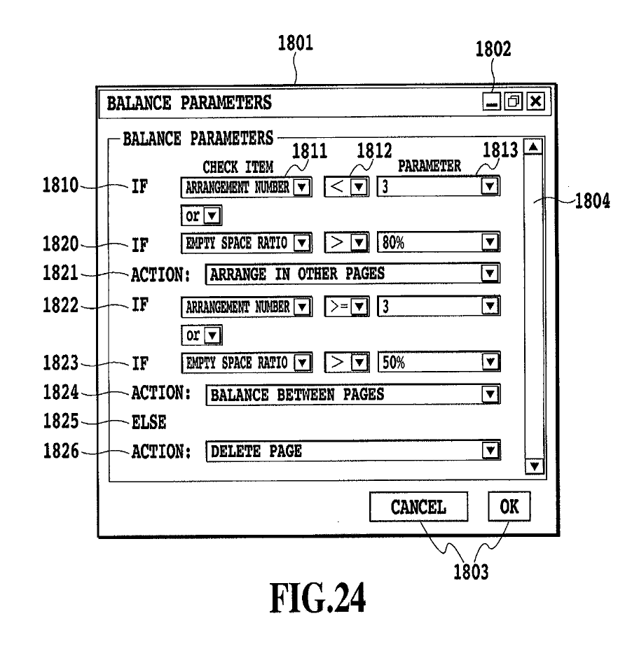

FIG. 24 shows one example of a balance parameters dialog box.

Reference numeral 1802 indicates a button for minimizing, maximizing, or closing the balance parameters dialog box. Reference numeral 1803 represents buttons for choosing to either apply or cancel the conditions (properties) input in the dialog box. Reference numeral 1804 represents a scroll bar in the dialog box. If a size of content data to be displayed is large, this scroll bar may be used to scroll a viewing area. In the balance parameters dialog box, if the number of sub-templates arranged in a page after an after-mentioned dynamic layout flow varies markedly depending on each page, how to rearrange the sub-templates can be set, for example. There can be set conditions such as “If the number of sub-templates arranged in one page is less than 3, the sub-templates are rearranged in other pages”. A procedure for setting the conditions is almost similar to that in the layout conditions dialog box 1701. However, in the balance parameters dialog box, “Arrangement number” and “Empty space ratio” are provided as conditional statements, as indicated by Reference numerals 1811 and 1820 respectively, but settings of various other conditional statements are possible. “Arrangement number” refers to the number of sub-templates arranged in a relevant page, and “Empty space ratio” a ratio of a total sub-template area to a relevant page area. In the item indicated by Reference numeral 1814, a logical expression such as “AND” or “OR” can be used to set a plurality of conditions. “Action” indicated by Reference numeral 1821, 1824 or 1826 is a box for setting how sub-templates move when the conditions are met. In this example, “Arrange in other pages”, “Balance between pages”, and “Delete page” are input.

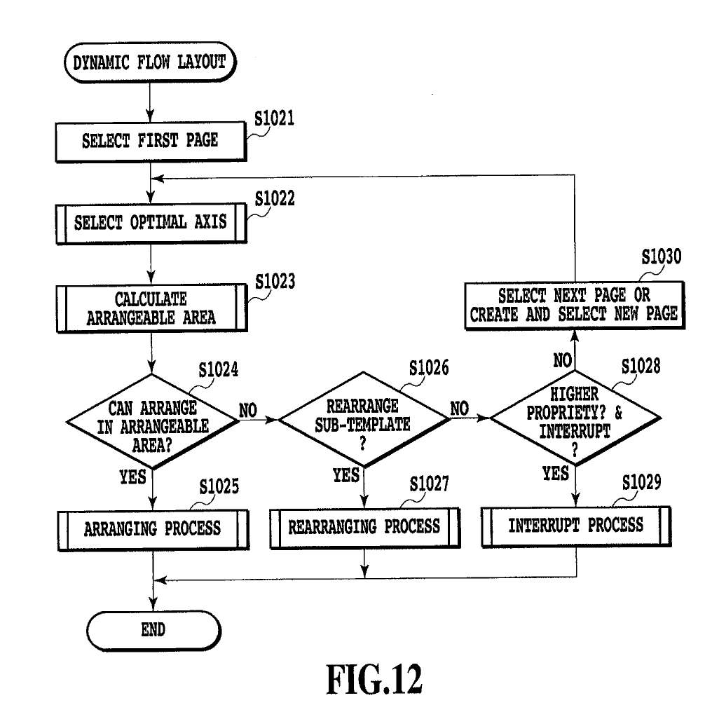

FIG. 12 shows a flowchart illustrating a flow of dynamic flow layout processing.

First, a first page of a document is selected (S1021).

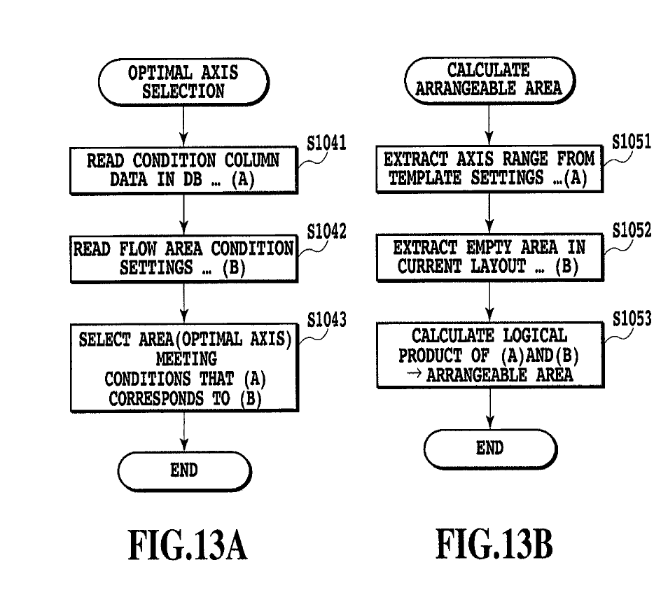

Then, an optimal axis is selected (S1022). The optimal axis refers to the best axis to which a sub-template is allocated. FIG. 13A is a flowchart illustrating a flow of an optimal axis selecting process. In step S1041, data in a condition column in the DB is read. That is, on the basis of values set in the layout conditions dialog box shown in FIG. 23, it is determined which axis is allocated with a relevant sub-template. Subsequently, in step S1042, flow area property settings are read. That is, axis settings created in the layout window dialog box shown in FIG. 18 are read. Subsequently, in step S1043, an optimal axis meeting the condition that the data read in step S1041 and settings read in step S1042 correspond to each other (e.g., Appeal axis for an appeal merchandise) is selected. Referring again to FIG. 12, after the selection of the optimal axis, an arrangeable area is calculated in step S1023. The arrangeable area refers to an area in which the relevant sub-template can be arranged. FIG. 13B is a flowchart illustrating a flow of a process for calculating the arrangeable area. First, in step S1051, an axis range is extracted from settings in the axis properties dialog box shown in FIG. 22. That is, the effective range of the axis is calculated on the basis of an axis position 1612 and an axis effective range 1613 set in the axis properties dialog box shown in FIG. 22. Then, in step S1052, an empty area within the flow area is extracted from the current layout. That is, the empty area is searched in the current layout condition of the flow area (arrangement condition of sub-templates). The empty area refers to an area within a flow area where any object such as a sub-template or a layout frame is not arranged. Subsequently, in step S1053, a logical product of results obtained in steps S1051 and S1052 is calculated, and then an area corresponding to the calculated logical product is set as the arrangeable area. Referring again to FIG. 12, after the setting of the arrangeable area, it is determined in step S1024 whether or not the relevant sub-template can be arranged in the arrangeable area. If the relevant sub-template can be arranged in the arrangeable area around the axis without overlapping with other sub-templates, the flow proceeds to step S1025 for an arranging process. On the other hand, if it is determined in step S1024 that the relevant sub-template cannot be arranged in the arrangeable area, the flow proceeds to step S1026 for a rearranging process of the sub-template.

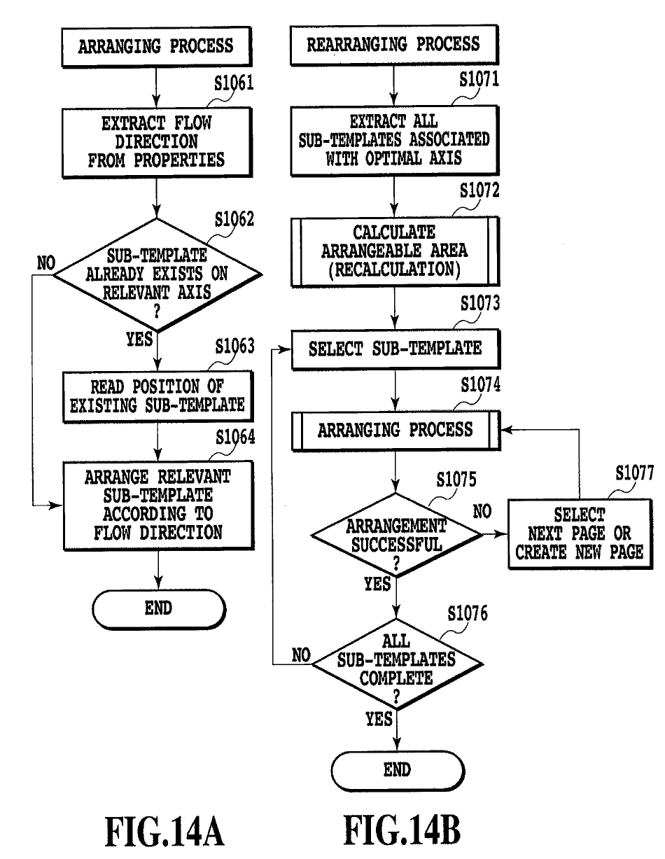

FIG. 14A is a flowchart illustrating a flow of the arranging process shown in FIG. 12 as step S1025.

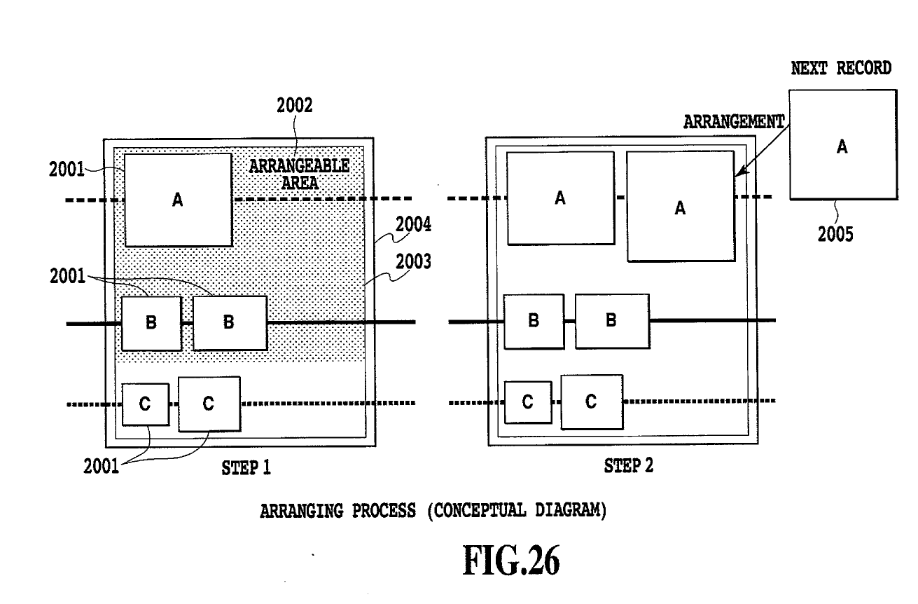

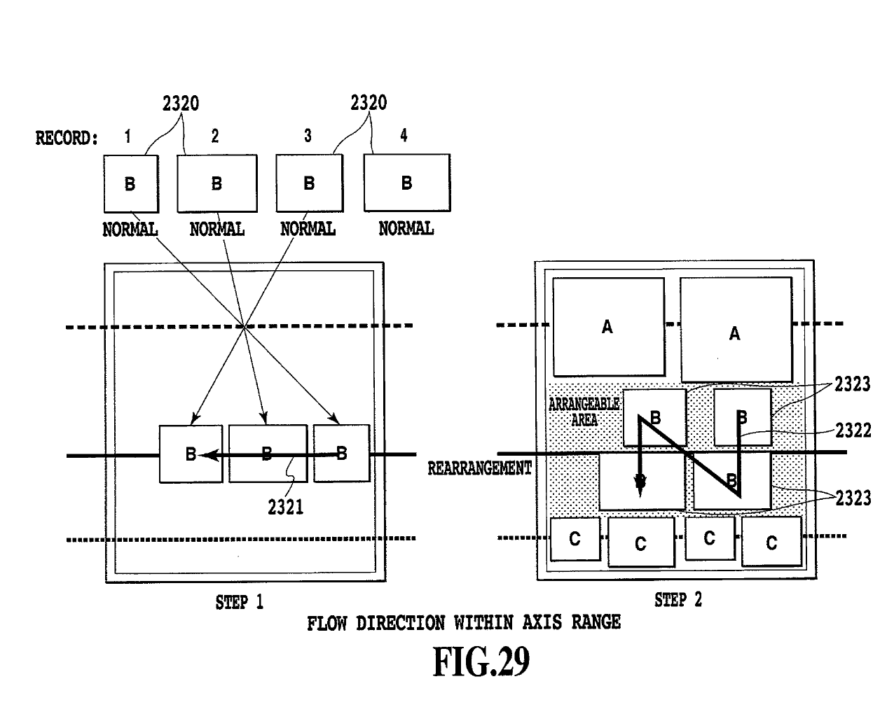

First, in step S1061, a value set for the item 1615 in the axis properties dialog box shown in FIG. 22 is extracted as a flow direction within the relevant axis range. Then, it is determined in step S1062 whether or not any sub-template exists on the axis, and if it exists, then the flow proceeds to step S1063, whereas if not, then the flow proceeds to step S1064. In step S1063, a position of the existing sub-template is read. In step S1064, the relevant sub-template is allocated to the relevant axis according to the flow direction. FIG. 26 is a conceptual diagram of a method for the arranging process based on the flowchart shown in FIG. 14A. Reference numerals 2003 and 2004 represent a flow area and a page, respectively. Rectangles indicated by Reference numeral 2001 represent the already-arranged sub-templates, and Reference numeral 2002 represents the arrangeable area. If a record (piece of content) 2005 is further arranged under the condition that the sub-templates have been arranged as described, the record (piece of content) 2005 is arranged in an area of an axis A because the axis A is the optimal axis. FIG. 29 shows a conceptual diagram for describing the process for rearranging a sub-template on the basis of a flow direction within an axis range. If there are a plurality of sub-templates indicated by Reference numeral 2320, the records (pieces of content) are allocated to an optimal axis B in a flow area in the order of the records (pieces of content) indicated by Reference numeral 2321, on the basis of a flow direction set for the item 1615 in the axis properties dialog box shown in FIG. 22. For example, if an N-shaped flow direction as indicated by Reference numeral 2322 is set for the item 1615, the sub-templates 2320 are arranged in an arrangeable area along the N shape from upper right to lower left, resulting in a layout shown by Reference numeral 2323.

Referring again to FIG. 12, in step S1024, if the relevant sub-template cannot be allocated to the optimal axis, it is determined in step S1026 whether or not sub-templates having been already allocated to the relevant axis are rearranged. If they are rearranged, the flow proceeds to the rearranging process in step S1027, whereas if not, the flow proceeds to step S1028. FIG. 14B shows a flowchart illustrating a flow of the rearranging process. In step S1071, already-arranged sub-templates associated with a relevant axis are all extracted, and arranged in the order from the small record (content) number to the large. Then, in step S1072, the arrangeable area obtained by the calculating process of an arrangeable area shown in FIG. 13 is recalculated with respect to the relevant axis, then in step S1073, the sub-templates are sequentially selected, and in step S1074, the arranging process shown in FIG. 14A is performed. After the arranging process in step S1074, it is determined in step S1075 whether or not the arrangement is successful, then if it is successful, the flow proceeds to step S1076, and the arranging process is repeated until all the sub-templates are arranged. If it is determined in step S1075 that the arrangement is not successful, the flow proceeds to step S1077, where if a next page exists, the next page is selected, whereas if not, a new page is created and the flow returns to the arranging process in step S1074.

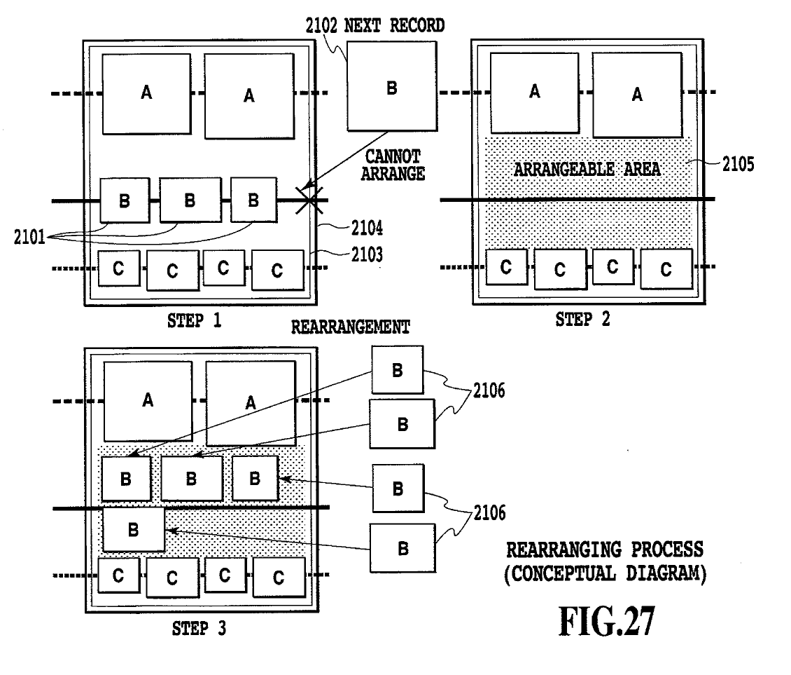

FIG. 27 is a conceptual diagram for describing a method for the rearranging process shown in FIG. 14B.

Reference numerals 2103 and 2104 represent a flow area and a page, respectively. Reference numeral 2101 indicates sub-templates allocated to a middle axis. In Step 1 of the diagram, a size of a sub-template 2102 for a next record (content) is too large to allocate the sub template 2102 to its optimal axis B. In such a case, as shown in Step 3, the sub-templates 2101 having been already allocated to the axis B and the sub-template 2102 for the next record (content) are arranged as indicated by Reference numeral 2106. Then, an arrangeable area of the axis B is recalculated to detect the arrangeable area 2105, i.e., a rearranging area. Subsequently, the sub-templates 2101 and 2102 are arranged in the arrangeable area 2105 on the basis of a flow direction set for the item 1615 in the axis properties dialog box shown in FIG. 22.

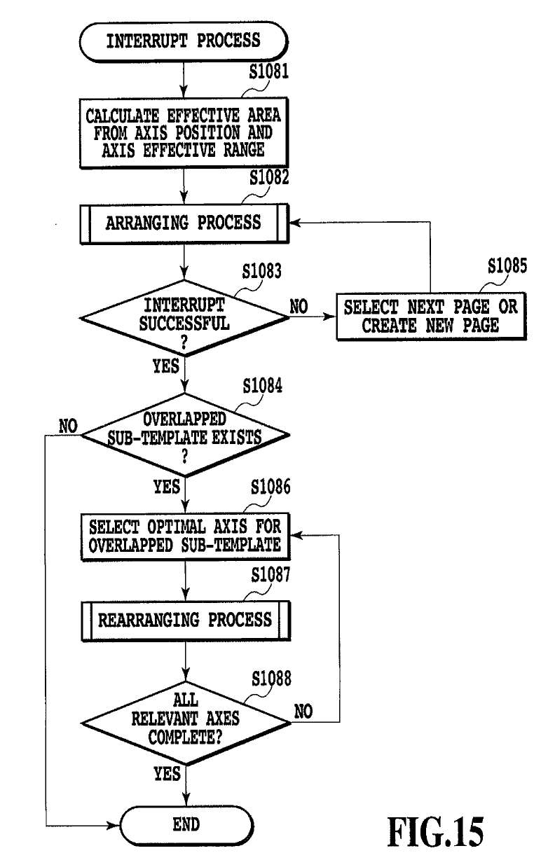

Referring again to FIG. 12, in step S1026, if the sub-templates cannot be rearranged, the flow proceeds to step S1028 and it is determined whether or not a sub-template interrupt is performed. If the interrupt is performed, it is determined based on a setting in the item 1614 of FIG. 22 whether or not a priority of the axis is higher than the axes around the relevant axis. If the priority indicated by the item 1614 is higher than neighboring axes, the flow proceeds to an interrupt process in step S1029, whereas if not, the flow proceeds to step S1030. FIG. 15 shows a flowchart illustrating a flow of the interrupt process.

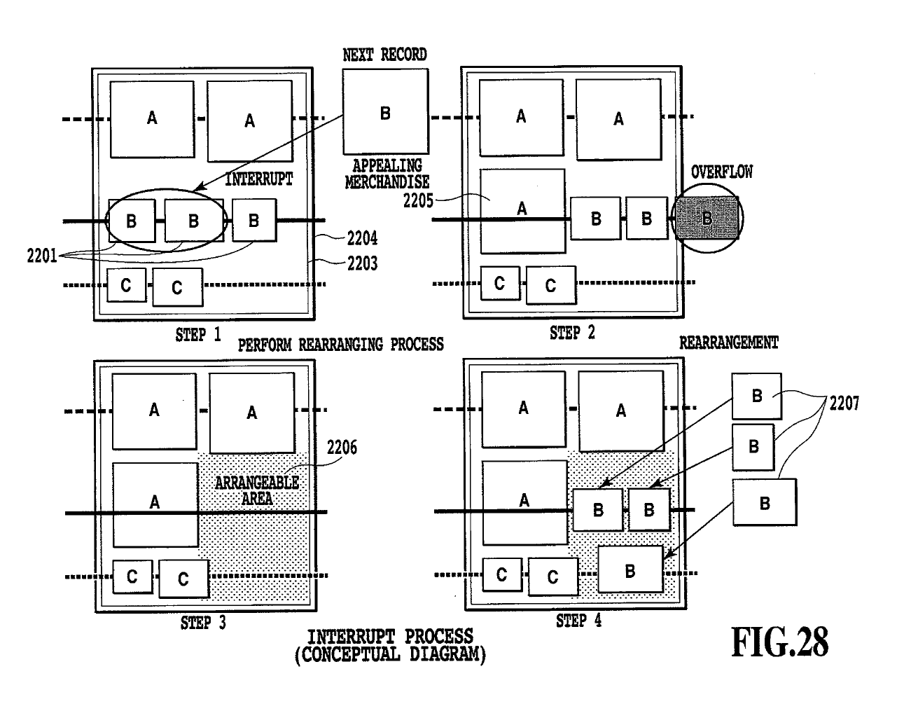

First, in step S1081, an area in which the sub-template is to be arranged is set on the basis of values in the items 1612 and 1613 shown in FIG. 22. This area does not refer to the arrangeable area, but a simple effective area of the axis. Then, in step S1082, the relevant sub-template is arranged in the area set in step S1081. Subsequently, it is determined in step S1083 whether or not the interrupt is successful, i.e., whether or not the arrangement in step S1082 is successful. If the arrangement is successful, the flow proceeds to step S1084, whereas if it is failed, the flow proceeds to step S1085 where a next page is selected, or a new page is created. In step S1084, it is determined whether or not the arranged sub-template overlaps with the other already-arranged sub-templates. If there is no overlapped sub-template, the interrupt process is ended. If there are any overlapped sub-templates, the flow proceeds to step S1086 where optimal axes for the overlapped sub-templates are selected. Then, the flow proceeds to step S1087 where the rearranging process is performed on one of the overlapped sub-templates. Subsequently, it is determined in step S1088 whether or not the rearranging process has been performed on all the overlapped sub-templates, and if it has not yet been performed on all the overlapped sub-templates, the flow returns to step S1086 where the rearranging process is performed on another sub-template. These steps are repeated until all the overlapped sub-templates are rearranged. FIG. 28 is a conceptual diagram for describing a method for the interrupt process shown in FIG. 15. Reference numerals 2203 and 2204 represent a flow area and a page, respectively. Reference numeral 2201 indicates sub-templates allocated to a middle axis. A next record (content) 2202 is allocated to an axis A, and if a priority of the axis A is higher than that of an axis B, the sub-template 2202 is arranged at a position indicated by Reference numeral 2205. This causes an interrupt, and the sub-templates 2201 having been allocated to the axis B is rearranged because the sub-template 2202 overlaps with them. A new arrangeable area 2206 of the axis B is calculated on the basis of the flow of the rearranging process shown in FIG. 14B, and then the sub-templates indicated by Reference numeral 2207 are sequentially arranged on the basis of the layout flow method. In step S1028 of FIG. 12, if the interrupt process is not performed, the flow proceeds to step S1030 where if there is a next page, the next page is selected, whereas if there is not a next page, a new page is created, then the flow again proceeds to the arranging process in step S1082 of FIG. 15, and the process is repeated until the arrangement is successful.

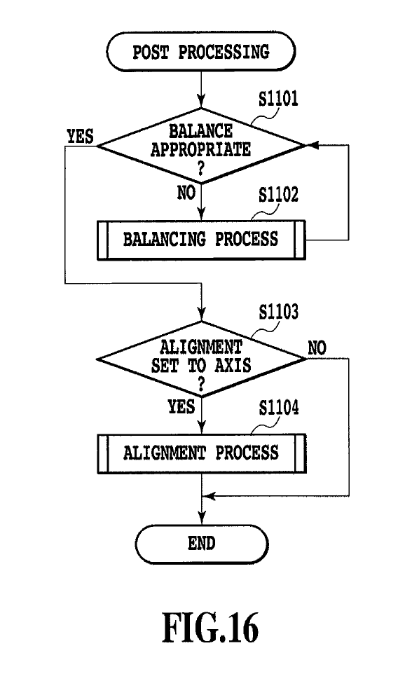

FIG. 16 shows a flowchart for the post processing in step S1016 of the flow layout processing shown in FIG. 11B.

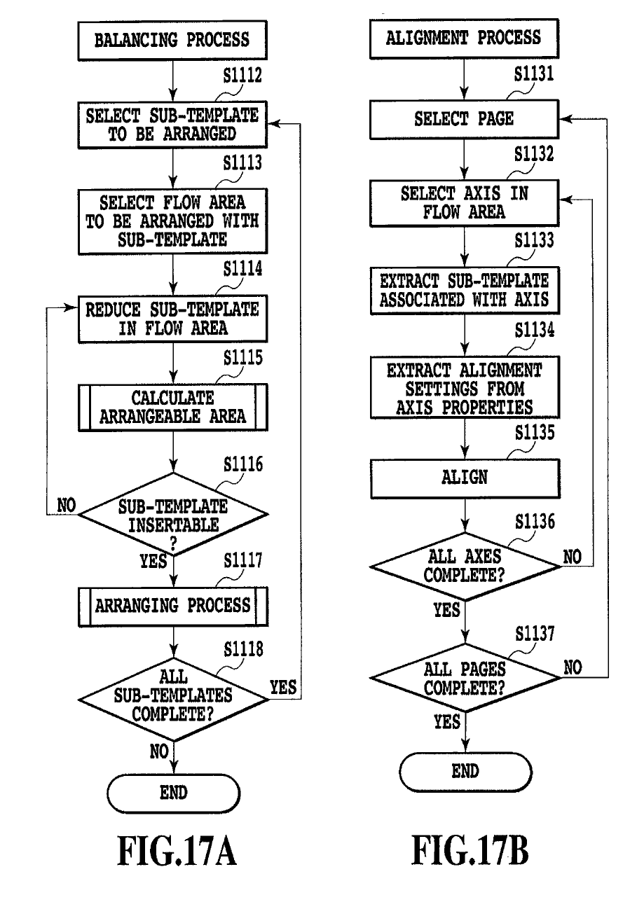

First, in step S1101, it is determined whether or not a balance is appropriate. The determination may be made by a user on the basis of a result of the dynamic flow layout; however, in this embodiment, from the viewpoint of layout automation, it is determined on the basis of whether or not conditions set in the balance parameters dialog box shown in FIG. 24 are applicable. In step S1101, it is determined on the basis of settings of the conditions whether or not the balance is appropriate, and if the balance is appropriate, the flow proceeds to an “If statement” in step S1103. If it is not appropriate, the flow proceeds to a balancing process in step S1102. FIG. 17 is a diagram illustrating a flowchart for the balancing process.

In the balance parameters dialog box in FIG. 24, “Arrange in other pages”, “Balance between pages”, and “Delete page” are shown as “Actions”, for example; however, in the balance processing flowchart, an “Arrange in other pages” option is taken among them for descriptive purpose. First, in step S1112, a sub-template to be arranged is selected. Then, in step S1113, a flow area in which the sub-template is to be arranged is selected. A selection method for the flow area may include various methods; however, in this example, assume that it is first checked whether or not a previous page has a flow area, and if it does not have any flow area, then it is checked whether or not a next page has a flow area. In this example, also assume that the flow area in the previous page is selected. Then, in step S1114, a sub-template in the flow area selected in step S1113 is reduced at a certain magnification. Subsequently, in step S1115, an arrangeable area is calculated on the basis of the method shown in FIG. 13B, and in step S1116, it is determined whether or not the sub-template selected in step S1112 can be inserted into the area. If the sub-template can be inserted, the arranging process is performed in step S1117 on the basis of the method shown in FIG. 14A. On the other hand, if it cannot be inserted, the flow returns to step S1114 where the sub-template in the flow area is again reduced at a certain magnification, and these steps are repeated until the sub-template selected in step S1112 can be inserted. After the arranging process in step S1117, it is determined in step S1118 whether or not the balancing process has been performed on all the relevant sub-templates, and if all the relevant sub-templates have not yet been processed, the process is repeated until the insertion of all the relevant sub-templates is complete.

Referring again to FIG. 16, in step S1101, if the balance is appropriate, it is determined in step S1103 whether or not an alignment is set for axes. If the alignment is set, an alignment process is performed in step S1104. FIG. 17B shows a flowchart for the alignment process.

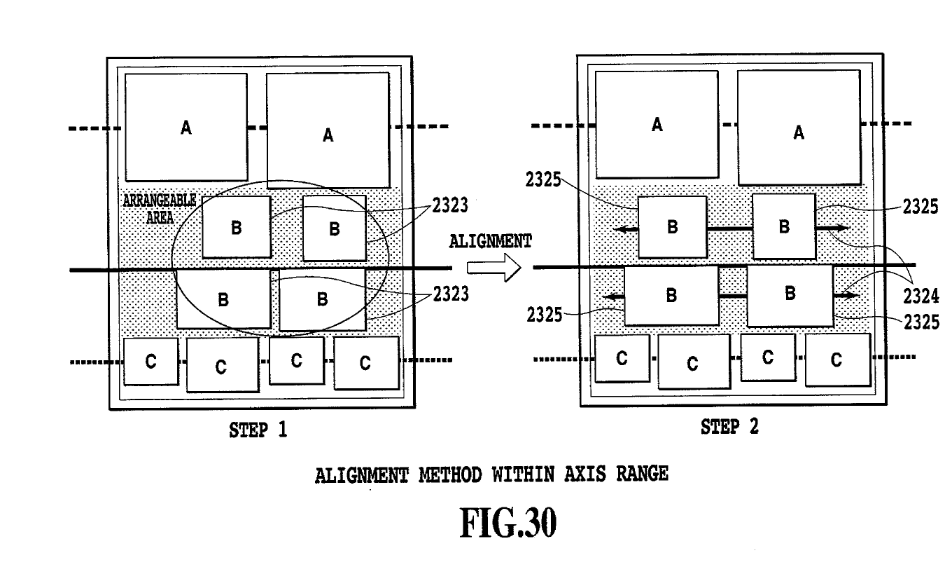

First, in step S1131, a page is selected, and then instep S1132, an axis is selected in a flow area. Subsequently, in step S1133, sub-templates allocated to the axis are extracted, and then in step S1134, an alignment direction within a range of the axis is extracted in the item 1616 in FIG. 22. Subsequently, in step S1135, the extracted sub-templates are aligned in the page according to the alignment direction extracted in the item 1616, and then these steps are performed on all axes and all pages through steps S1136 and S1137. FIG. 30 shows a conceptual diagram of the alignment method within an axis range. Sub-templates laid out as indicated by Reference numeral 2323 are aligned on the basis of a setting in the item 1616. In this case, because an equal layout is set as indicated by Reference numeral 2324, the sub-templates 2323 are moved to be equalized with respect to a page or a flow area, resulting in a layout as shown by Reference numeral 2325.

### 4. Other Embodiments

It should be appreciated that an object of the present invention can be accomplished by reading and executing a program code that a computer (or a CPU or a MPU) of a system or a device stores on a storage medium (or a recording medium). The storage medium records thereon the software program code implementing features of the foregoing embodiment. In this case, the program code itself read from the storage medium implements the features of the foregoing embodiment. Also, the storage medium storing the program code thereon constitutes the present invention. Furthermore, on the basis of instructions of the program code read by a computer, an operating system (OS) running on the computer performs actual processing in part or in whole, and if the processing results in the implementation of the features of the foregoing embodiment, such a case is also included in the present invention.

The program code read from the storage medium is written into a memory provided in an extension card inserted into the computer or provided in an extension unit connected to the computer, and then the features of the foregoing embodiment may be implemented. That is, on the basis of the instructions of the program code read from the storage medium, a CPU or the like provided in the extension card or the expansion unit may perform the actual processing in part or in whole.

If the present invention is applied to the above storage medium, the storage medium stores thereon the program code that corresponds to the already-described flowcharts.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-163827, filed Jun. 13, 2006, which is hereby incorporated by reference herein in its entirety.

What is claimed is:

1. An automatic layout system for varying a layout of a sub-template for content depending on a size of the content to be laid out on a page, comprising:
a module setting an area for flowing the sub-template in the page;
a module setting position information in the page;
a module setting content information for the content; and
a module deciding the layout of the sub-template according to the position information and the content information.

2. The automatic layout system of claim 1, wherein the position information represents a characteristic of each area in the page, and the content information represents a characteristic of the content.

3. The automatic layout system of claim 2, wherein the position information is shown by an axis set in the page.

4. The automatic layout system of claim 3, wherein a predetermined range about the axis is used as an allowable range, and the sub-template is arranged within the allowable range.

5. The automatic layout system of claim 1, further comprising:
a module setting a flow direction of the sub-template for each area in the page; and
a module arranging the sub-template according to the flow direction.

6. The automatic layout system of claim 1, further comprising:
a module setting an alignment of the sub-template for each area in the page; and
a module arranging the sub-template according to the alignment.

7. The automatic layout system of claim 1, further comprising:
a module detecting a rearrangement area if the sub-template extends over a plurality of pages; and
a module rearranging the sub-template in the rearrangement area.

8. An automatic layout method for varying a layout of a sub-template for content depending on a size of the content to be laid out on a page, comprising the steps of:
setting an area for flowing the sub-template in the page;
setting position information in the page;
setting content information for the content; and
deciding the layout of the sub-template according to the position information and the content information.

9. A computer-readable medium having computer-executable instructions to vary a layout of a sub-template for content depending on a size of the content to be laid out on a page, which when executed perform steps, comprising:
setting an area for flowing the sub-template in the page;
setting position information in the page;
setting content information for the content; and
deciding the layout of the sub-template according to the position information and the content information.

10. An information processor for varying a layout of content depending on a size of the content to be laid out on a page, comprising:
a setting module setting a characteristic for each area in the page; and
a processing module laying out the content according to a characteristic of the content and the characteristic of the each area set by the setting module.

11. An information processing method for varying a layout of content depending on a size of the content to be laid out on a page, comprising the steps of:
setting a characteristic for each area in the page; and
laying out the content according to a characteristic of the content and the set characteristic of the each area.

12. A computer-readable medium having computer-executable instructions to vary a layout of content depending on a size of the content to be laid out on a page, which when executed perform steps, comprising:
setting a characteristic for each area in the page; and
laying out the content according to a characteristic of the content and the set characteristic of the each area.
